(19) United States
(12) Patent Application Publication
(10) Pub. No.: US 2026/0051920 A1
(43) Pub. Date: Feb. 19, 2026

(54) RADIO FREQUENCY CIRCUIT AND COMMUNICATION DEVICE

(71) Applicant: Murata Manufacturing Co., Ltd., Nagaokakyo-shi (JP)

(72) Inventors: Atsushi ONO, Nagaokakyo-shi (JP); Shinya HITOMI, Nagaokakyo-shi, Kyoto (JP); Hirotsugu MORI, Nagaokakyo-shi, Kyoto (JP)

(73) Assignee: Murata Manufacturing Co., Ltd., Nagaokakyo-shi (JP)

(21) Appl. No.: 19/369,377

(22) Filed: Oct. 27, 2025

Related U.S. Application Data
(63) Continuation of application No. PCT/JP2024/014321, filed on Apr. 8, 2024.

(30) Foreign Application Priority Data
Apr. 28, 2023 (JP) 2023-074592

(51) Int. Cl. H04B 1/401; H04B 1/04

(52) U.S. Cl. CPC H04B 1/401; H04B 1/0483; H04B 2001/0408

(57) ABSTRACT

A radio frequency circuit includes a first transfer circuit including a first power amplifier, a second power amplifier, and a first switch circuit; and a second transfer circuit including a third power amplifier and a second switch circuit. The first switch circuit includes first and second input/output terminals, first and second antenna terminals, first and second inter-module terminals. The second switch circuit includes a third input/output terminal, third and fourth antenna terminals, third and fourth inter-module terminals. The first to third power amplifiers are respectively connected to the first to third input/output terminals. The first inter-module terminal is connected to the third inter-module terminal. The second inter-module terminal is connected to the fourth inter-module terminal. The first to third input/output terminals are each selectively connectable to the first antenna terminal, the second antenna terminal, the third antenna terminal, and the fourth antenna terminal.

### CROSS-REFERENCE TO RELATED APPLICATIONS

This is a continuation application of PCT International Application No. PCT/JP2024/014321 filed on Apr. 8, 2024, designating the United States of America, which is based on and claims priority of Japanese Patent Application No. 2023-074592 filed on Apr. 28, 2023. The entire disclosures of the above-identified applications, including the specifications, drawings, and claims are incorporated herein by reference in their entirety.

### BACKGROUND

### 1. Field

The present disclosure relates to a radio frequency (RF) circuit and a communication device.

### 2. Description of the Related Art

A multi-band and multi-mode front-end circuit is to transmit and receive a plurality of RF signals with low loss and high isolation.

United States Patent Application Publication No. 2016/0127015 discloses a reception module (RF module) having a configuration in which a plurality of filters having different pass bands are connected to an antenna via a multiplexer (switch).

### SUMMARY

Band combinations for simultaneous transfer (Eutra NR Dual Connectivity (ENDC) and UpLink Carrier Aggregation (ULCA)) defined by 3rd Generation Partnership Project (3GPP, registered trademark) have been increasing. Accordingly, a plurality of antennas are to be connected to an RF circuit including a plurality of power amplifiers. In this case, heat dissipation efficiency is to be increased to reduce deterioration of signal quality. However, an increase in heat dissipation efficiency may involve an increase in the size of the RF circuit.

Accordingly, the present disclosure is directed to providing an RF circuit and a communication device that are compact and that reduce deterioration of signal quality during simultaneous transfer.

A radio frequency circuit according to an aspect of the present disclosure includes a first transfer circuit including a first power amplifier, a second power amplifier, and a first switch circuit; and a second transfer circuit including a third power amplifier and a second switch circuit. The first switch circuit includes a first input/output terminal, a second input/output terminal, a first antenna terminal, a second antenna terminal, a first terminal, and a second terminal. The second switch circuit includes a third input/output terminal, a third antenna terminal, a fourth antenna terminal, a third terminal, and a fourth terminal. The first power amplifier is connected to the first input/output terminal. The second power amplifier is connected to the second input/output terminal. The third power amplifier is connected to the third input/output terminal. The first terminal is connected to the third terminal. The second terminal is connected to the fourth terminal. The first input/output terminal, the second input/output terminal, and the third input/output terminal are each selectively connectable to the first antenna terminal, the second antenna terminal, the third antenna terminal, and the fourth antenna terminal.

A communication device according to an aspect of the present disclosure includes the radio frequency circuit according to the above aspect, and a signal processing circuit configured to process a radio frequency signal transferred in the radio frequency circuit.

According to the present disclosure, it is possible to provide an RF circuit and a communication device that are compact and that reduce deterioration of signal quality during simultaneous transfer.

### BRIEF DESCRIPTION OF THE DRAWINGS

FIG. 1 is a circuit configuration diagram of a radio frequency (RF) circuit and a communication device according to a first embodiment;

FIG. 2 is a diagram illustrating a first operation example of the RF circuit according to the first embodiment;

FIG. 3 is a diagram illustrating a second operation example of the RF circuit according to the first embodiment;

FIG. 4 is a diagram illustrating a third operation example of the RF circuit according to the first embodiment;

FIG. 5 is a circuit configuration diagram of an RF circuit according to a second embodiment;

FIG. 6 is a diagram illustrating a first operation example of the RF circuit according to the second embodiment;

FIG. 7 is a diagram illustrating a second operation example of the RF circuit according to the second embodiment;

FIG. 8 is a diagram illustrating a third operation example of the RF circuit according to the second embodiment;

FIG. 9 is a circuit configuration diagram of an RF circuit according to a third embodiment;

FIG. 10 is a diagram illustrating a first operation example of the RF circuit according to the third embodiment;

FIG. 11 is a diagram illustrating a second operation example of the RF circuit according to the third embodiment;

FIG. 12 is a diagram illustrating a third operation example of the RF circuit according to the third embodiment;

FIG. 13 is a diagram illustrating a fourth operation example of the RF circuit according to the third embodiment; and

FIG. 14 is a circuit configuration diagram of an RF circuit according to a fourth embodiment.

### DESCRIPTION OF THE EMBODIMENTS

Hereinafter, embodiments will be described in detail with reference to the drawings. The embodiments described below each illustrate a general or specific example. The numerical values, shapes, materials, constituent elements, the arrangement and connection manner of the constituent elements, and so forth described in the following embodiments are merely examples, and are not intended to limit the present disclosure.

The drawings are schematic diagrams drawn with emphasis, omission, or ratio adjustment performed as appropriate in order to illustrate the present disclosure. The illustration therein is not necessarily strict, and may be different from actual shapes, positional relationships, and ratios. In the drawings, constituent elements that are substantially the same are denoted by the same reference numerals, and a repeated description thereof may be omitted or simplified.

In the present disclosure, “connected” includes not only a direct connection using a connection terminal and/or a wiring conductor, but also an electrical connection via another circuit element. “Connected between A and B” means connected to A and B on a path connecting A and B.

A “terminal” means a point at which a conductor in an element terminates. In a case where the impedance of a conductor between elements is sufficiently low, a terminal is interpreted as not only a single point but also any point on the conductor between the elements or the entire conductor.

In the present disclosure, a “transmission path” means a transfer line constituted by a wiring line through which a radio frequency (RF) transmission signal propagates, an electrode directly connected to the wiring line, a terminal directly connected to the wiring line or the electrode, and so forth. A “reception path” means a transfer line constituted by a wiring line through which an RF reception signal propagates, an electrode directly connected to the wiring line, a terminal directly connected to the wiring line or the electrode, and so forth.

In this specification, ordinal numerals such as “first” and “second” do not mean the number or order of constituent elements and are used to avoid confusion about the same types of constituent elements and discriminate therebetween, except where specifically noted.

### First Embodiment

Hereinafter, a first embodiment will be described.

### 1. CIRCUIT CONFIGURATIONS OF RF CIRCUIT 1 AND COMMUNICATION DEVICE 6

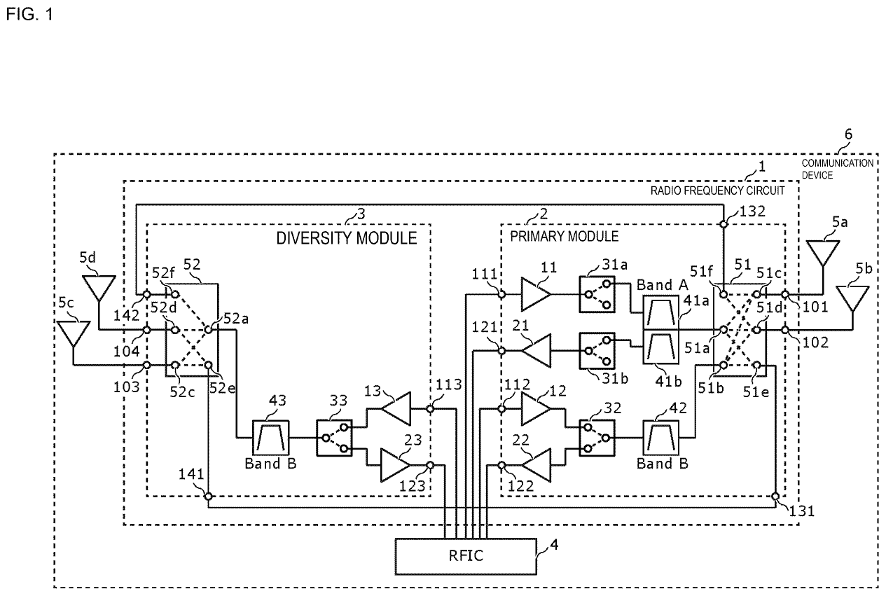

The circuit configurations of an RF circuit 1 and a communication device 6 according to the present embodiment will be described with reference to FIG. 1. FIG. 1 is a circuit configuration diagram of the RF circuit 1 and the communication device 6 according to the present embodiment.

FIG. 1 illustrates an exemplary circuit configuration. The communication device 6 can be implemented by using any of a wide variety of circuit implementations and circuit techniques. Thus, the description of the communication device 6 provided below is not to be construed in a limiting manner.

### 1.1 CIRCUIT CONFIGURATION OF COMMUNICATION DEVICE 6

First, the circuit configuration of the communication device 6 will be described.

The communication device 6 according to the present embodiment corresponds to user equipment (UE) in a cellular network (also referred to as a mobile network) and is typically a mobile phone, a smartphone, a tablet computer, a wearable device, or the like. The communication device 6 may be an Internet of Things (IoT) sensor device, a medical/health-care device, a vehicle, an unmanned aerial vehicle (UAV) (a so-called drone), or an automated guided vehicle (AGV). The communication device 6 may function as a base station (BS) in a cellular network.

As illustrated in FIG. 1, the communication device 6 includes the RF circuit 1, an RF signal processing circuit (RFIC) 4, and first to fourth antennas 5a, 5b, 5c, and 5d.

The RF circuit 1 transfers RF signals between the antennas 5a, 5b, 5c, and 5d and the RFIC 4. The RF circuit 1 includes a primary module 2 and a diversity module 3. The specific circuit configurations of the primary module 2 and the diversity module 3 will be described below.

The RF circuit 1 according to the present embodiment supports simultaneous transmission of three RF signals (3Tx). To be specific, the RF circuit 1 is capable of selecting three antennas from among the antennas 5a, 5b, 5c, and 5d and simultaneously transmitting RF signals from the three selected respective antennas.

3Tx means an operation mode in which three power amplifiers simultaneously operate. In 3Tx, the three power amplifiers respectively amplify three RF signals. The three RF signals include a signal of a first band (band A) and two signals of a second band (band B).

In the present disclosure, a band means a frequency band defined in advance, for a communication system constructed by using radio access technology (RAT), by a standardizing body or the like (for example, 3rd Generation Partnership Project (3GPP, registered trademark), Institute of Electrical and Electronics Engineers (IEEE), or the like). In each embodiment or the like, the communication system may be, but is not limited to, a Long Term Evolution (LTE) system, a 5th Generation New Radio (5G-NR) system, a Wireless Local Area Network (WLAN) system, or the like, for example.

An uplink operation band means a frequency range designated for uplink in the foregoing bands. A downlink operation band means a frequency range designated for downlink in the foregoing bands.

The combinations in the following Table 1 can be used as a combination of band A and band B supporting 3Tx, for example.

TABLE 1

| | Band | Band | |
|---|---|---|---|
| Band Combination | A | B | Power Class |
| CA_n28A-n41A | n28 | n41 | PC3@n28 1Tx; PC2@n41 2Tx; |
| | | | CA power class PC2 |
| CA_n28A-n78A | n28 | n78 | PC3@n28 1Tx; PC3/2@n78 2Tx; |
| | | | CA power class PC2 |
| CA_n8A-n78A | n8 | n78 | PC3@n8 1Tx; PC2@n78 2Tx; |
| | | | CA power class PC2 |
| CA_n41A-n71A | n41 | n71 | PC3@n71 1Tx; PC2@n41 2Tx; |
| | | | CA power class PC2 |
| | | | PC3@n71 1Tx; PC1.5@n41 2Tx; |
| | | | CA power class PC1.5 |
| CA_n41A-n77A | n41 | n77 | PC2@n41 1Tx; PC2@n77 2Tx; |
| | | | CA power class PC2 |
| | | | PC2@n41 2Tx; PC2@n77 1Tx; |
| | | | CA power class PC2 |
| CA_n26A-n78A | n26 | n78 | PC3@n26 1Tx; PC2@n78 2Tx; |
| | | | CA power class PC2 |
| DC_3A_n78A | 3 | n78 | PC3@n3 1Tx; PC2@n78 2TX; |
| | | | EN-DC power class PC2 |
| DC_40A_n78A | 40 | n78 | PC3@n40 1Tx; PC3/2@n78 2Tx; |
| | | | EN-DC power class PC2 |

The combination of bands is not limited to the examples given above. For example, the bands of the three RF signals may be different from each other. That is, the three power amplifiers may amplify an RF signal of band A, an RF signal of band B, and an RF signal of band C, respectively, and the three RF signals of bands A to C may be simultaneously transmitted from three respective antennas selected from among the antennas 5a, 5b, 5c, and 5d.

The rightmost column in the foregoing Table 1 shows the number of operations and power class of each power amplifier. To be specific, 1Tx means that the number of operations of the power amplifier that amplifies a signal of a corresponding band is one. 2Tx means that the number of operations of the power amplifier that amplifies a signal of a corresponding band is two. PC2 and PC3 mean power class 2 and power class 3, respectively. PC3/2 means power class 3 or power class 2.

For example, “PC3@n28 1Tx” means that a signal of band n28 is amplified by one power amplifier so that the signal is output in power class 3. “PC2@n41 2Tx” means that a signal of band n41 is amplified by two power amplifiers so that the signal is output in power class 2. “CA power class” and “EN-DC power class” each mean the total power class for simultaneously transmitting transmission signals of a set of corresponding bands.

A power class is classification of output power of a terminal defined by maximum output power. As the value of the power class decreases, the maximum permissible output power increases. For example, in 3GPP (registered trademark), the maximum output power of power class 1 (PC1) is 31 dBm, the maximum output power of power class 1.5 (PC1.5) is 29 dBm, the maximum output power of power class 2 (PC2) is 26 dBm, and the maximum output power of power class 3 (PC3) is 23 dBm.

The maximum output power of a terminal is defined by the maximum output power at an antenna end. The maximum output power of UE is measured in a method defined by 3GPP (registered trademark) or the like. For example, in FIG. 1, the maximum output power is measured by measuring radiation power in the antenna 5a, 5b, 5c, or 5d. The maximum output power of the antenna 5a, 5b, 5c, or 5d can be measured by providing a terminal near the antenna 5a, 5b, 5c, or 5d and connecting a measurer (for example, a spectrum analyzer) to the terminal, instead of measuring radiation power.

The RFIC 4 is an example of a signal processing circuit configured to process an RF signal. To be specific, the RFIC 4 performs signal processing such as down-conversion on an RF reception signal input through a reception path of the RF circuit 1, and outputs the reception signal generated through the signal processing to a baseband signal processing circuit (BBIC). The RFIC 4 performs signal processing such as up-conversion on a transmission signal input from the BBIC, and outputs the RF transmission signal generated through the signal processing to a transmission path of the RF circuit 1. The RFIC 4 includes a controller that controls a switch, an amplifier, and so forth included in the RF circuit 1. Some or all of the functions of the controller of the RFIC 4 may be implemented in the outside of the RFIC 4, for example, in the RF circuit 1 or the BBIC.

The BBIC is a baseband signal processing circuit that performs signal processing by using an intermediate frequency band lower than the frequency of an RF signal transferred by the RF circuit 1. The signal to be processed by the BBIC may be, for example, an image signal for displaying an image, and/or an audio signal for a telephone call using a speaker.

The antenna 5a is connected to an antenna connection terminal 101 of the RF circuit 1. The antenna 5a transmits an RF signal output from the RF circuit 1. The antenna 5a receives an RF signal from the outside and outputs the RF signal to the RF circuit 1.

The antenna 5b is connected to an antenna connection terminal 102 of the RF circuit 1. The antenna 5b transmits an RF signal output from the RF circuit 1. The antenna 5b receives an RF signal from the outside and outputs the RF signal to the RF circuit 1.

The antenna 5c is connected to an antenna connection terminal 103 of the RF circuit 1. The antenna 5c transmits an RF signal output from the RF circuit 1. The antenna 5c receives an RF signal from the outside and outputs the RF signal to the RF circuit 1.

The antenna 5d is connected to an antenna connection terminal 104 of the RF circuit 1. The antenna 5d transmits an RF signal output from the RF circuit 1. The antenna 5d receives an RF signal from the outside and outputs the RF signal to the RF circuit 1.

The configuration of the communication device 6 is not limited to the example illustrated in FIG. 1. For example, the communication device 6 may include a BBIC. Alternatively, the communication device 6 does not necessarily have to include the antenna 5a, 5b, 5c, or 5d.

### 1.2 CIRCUIT CONFIGURATION OF PRIMARY MODULE 2

Next, the circuit configuration of the primary module 2 will be described.

The primary module 2 is an example of a first transfer circuit. As illustrated in FIG. 1, the primary module 2 includes power amplifiers 11 and 12, low-noise amplifiers 21 and 22, switches 31a, 31b, and 32, filters 41a, 41b, and 42, an antenna switch 51, the antenna connection terminals 101 and 102, RF input terminals 111 and 112, RF output terminals 121 and 122, and diversity connection terminals 131 and 132.

The antenna connection terminals 101 and 102, the RF input terminals 111 and 112, the RF output terminals 121 and 122, and the diversity connection terminals 131 and 132 are each an external connection terminal included in the primary module 2.

The antenna connection terminal 101 is connected to the antenna 5a outside the primary module 2 and is connected to an antenna terminal 51c of the antenna switch 51 inside the primary module 2. The antenna connection terminal 102 is connected to the antenna 5b outside the primary module 2 and is connected to an antenna terminal 51d of the antenna switch 51 inside the primary module 2.

The RF input terminal 111 is connected to the RFIC 4 outside the primary module 2 and is connected to an input end of the power amplifier 11 inside the primary module 2. The RF input terminal 112 is connected to the RFIC 4 outside the primary module 2 and is connected to an input end of the power amplifier 12 inside the primary module 2.

The RF output terminal 121 is connected to the RFIC 4 outside the primary module 2 and is connected to an output end of the low-noise amplifier 21 inside the primary module 2. The RF output terminal 122 is connected to the RFIC 4 outside the primary module 2 and is connected to an output end of the low-noise amplifier 22 inside the primary module 2.

The diversity connection terminal 131 is connected to a primary connection terminal 141 of the diversity module 3 outside the primary module 2 and is connected to a diversity terminal 51e of the antenna switch 51 inside the primary module 2. The diversity connection terminal 132 is connected to a primary connection terminal 142 of the diversity module 3 outside the primary module 2 and is connected to a diversity terminal 51f of the antenna switch 51 inside the primary module 2.

The power amplifier 11 is an example of a first power amplifier and is configured to amplify an RF transmission signal (hereinafter referred to as a transmission signal) of the first band (band A) output from the RFIC 4. The input end of the power amplifier 11 is connected to the RF input terminal 111. An output end of the power amplifier 11 is connected to an input/output terminal 51a of the antenna switch 51 via the switch 31a and the filter 41a.

The power amplifier 12 is an example of a second power amplifier and is configured to amplify a transmission signal of the second band (band B) output from the RFIC 4. The input end of the power amplifier 12 is connected to the RF input terminal 112. An output end of the power amplifier 12 is connected to an input/output terminal 51b of the antenna switch 51 via the switch 32 and the filter 42.

The low-noise amplifier 21 is configured to amplify an RF reception signal (hereinafter referred to as a reception signal) of the first band received by any one of the antennas 5a, 5b, 5c, and 5d. An input end of the low-noise amplifier 21 is connected to the input/output terminal 51a of the antenna switch 51 via the switch 31b and the filter 41b. The output end of the low-noise amplifier 21 is connected to the RF output terminal 121.

The low-noise amplifier 22 is configured to amplify a reception signal of the second band received by any one of the antennas 5a, 5b, 5c, and 5d. An input end of the low-noise amplifier 22 is connected to the input/output terminal 51b of the antenna switch 51 via the switch 32 and the filter 42. The output end of the low-noise amplifier 22 is connected to the RF output terminal 122.

The switch 31a is a switch for switching a transfer destination of a transmission signal output by the power amplifier 11. To be specific, the switch 31a is a single-pole double-throw (SPDT) switch having a common terminal and two selection terminals. The common terminal of the switch 31a is connected to the output end of the power amplifier 11. One of the two selection terminals of the switch 31a is connected to an input end of the filter 41a. The other of the two selection terminals of the switch 31a is connected to, for example, an input end of a filter. The number of selection terminals of the switch 31a may be three or more.

The switch 31b is a switch for switching a transfer source of a reception signal to be input to the low-noise amplifier 21. To be specific, the switch 31b is an SPDT switch having a common terminal and two selection terminals. The common terminal of the switch 31b is connected to the input end of the low-noise amplifier 21. One of the two selection terminals of the switch 31b is connected to an output end of the filter 41b. The other of the two selection terminals of the switch 31b is connected to, for example, an output end of a filter. The number of selection terminals of the switch 31b may be three or more.

The switch 32 is a switch for switching a signal to pass through the filter 42 between a transmission signal and a reception signal. That is, the switch 32 is a transmission/reception switching switch (time division duplex (TDD) switch) for switching between transmission and reception of a band included in the pass band of the filter 42. To be specific, the switch 32 is an SPDT switch having a common terminal and two selection terminals. The common terminal of the switch 32 is connected to one end of the filter 42. One of the two selection terminals of the switch 32 is connected to the output end of the power amplifier 12. The other of the two selection terminals of the switch 32 is connected to the input end of the low-noise amplifier 22. The number of selection terminals of the switch 32 may be three or more.

The filter 41a is an example of a first filter and is connected between the power amplifier 11 and the input/output terminal 51a of the antenna switch 51. To be specific, the input end of the filter 41a is connected to the power amplifier 11 via the switch 31a. An output end of the filter 41a is connected to the input/output terminal 51a of the antenna switch 51.

The filter 41b is connected between the low-noise amplifier 21 and the input/output terminal 51a of the antenna switch 51. To be specific, an input end of the filter 41b is connected to the input/output terminal 51a of the antenna switch 51. The output end of the filter 41b is connected to the low-noise amplifier 21 via the switch 31b.

The filters 41a and 41b constitute a duplexer. The filters 41a and 41b each have a pass band including at least part of band A (first band). To be specific, the filter 41a has a pass band including an uplink operation band of band A. The filter 41b has a pass band including a downlink operation band of band A. Band A is a band for frequency division duplex (FDD), but is not limited thereto and may be a band for time division duplex (TDD). In this case, a TDD filter and a transmission/reception switching switch, instead of the filters 41a and 41b, are provided between the input/output terminal 51a and a set of the power amplifier 11 and the low-noise amplifier 21. The switches 31a and 31b do not necessarily have to be provided, or may be integrated with the transmission/reception switching switch.

The filter 42 is an example of a second filter and is connected between the power amplifier 12 and the input/output terminal 51b of the antenna switch 51. To be specific, the one end of the filter 42 is connected to each of the power amplifier 12 and the low-noise amplifier 22 via the switch 32. The other end of the filter 42 is connected to the input/output terminal 51b of the antenna switch 51.

The filter 42 has a pass band including at least part of band B (second band). Band B is a band for TDD, but is not limited thereto and may be a band for FDD. In this case, a duplexer, instead of the filter 42 and the switch 32, is provided between the input/output terminal 51b and a set of the power amplifier 12 and the low-noise amplifier 22. The duplexer is constituted by a filter having a pass band including an uplink operation band of the band for FDD and a filter having a pass band including a downlink operation band of the band for FDD.

The antenna switch 51 is an example of a first switch circuit and includes the input/output terminals 51a and 51b, the antenna terminals 51c and 51d, and the diversity terminals 51e and 51f.

The input/output terminal 51a is an example of a first input/output terminal and is connected to the power amplifier 11. To be specific, the input/output terminal 51a is connected to the output end of the power amplifier 11 via the filter 41a and the switch 31a.

The input/output terminal 51b is an example of a second input/output terminal and is connected to the power amplifier 12. To be specific, the input/output terminal 51b is connected to the output end of the power amplifier 12 via the filter 42 and the switch 32.

The antenna terminal 51c is an example of a first antenna terminal and is connected to the antenna 5a via the antenna connection terminal 101. The antenna terminal 51d is an example of a second antenna terminal and is connected to the antenna 5b via the antenna connection terminal 102.

The diversity terminal 51e is an example of a first inter-module terminal (first diversity terminal) and is connected to a primary terminal 52e of an antenna switch 52 included in the diversity module 3. To be specific, the diversity terminal 51e is connected to the primary terminal 52e via the diversity connection terminal 131 and the primary connection terminal 141.

The diversity terminal 51f is an example of a second inter-module terminal (second diversity terminal) and is connected to a primary terminal 52f of the antenna switch 52 included in the diversity module 3. To be specific, the diversity terminal 51f is connected to the primary terminal 52f via the diversity connection terminal 132 and the primary connection terminal 142.

The antenna switch 51 is a multi-connection switch circuit, i.e., is a configurable switch matrix configured to selectively establish signal paths between its various terminals under the control of a controller. The input/output terminals 51a and 51b are each selectively connectable to at least the antenna terminals 51c and 51d and the diversity terminal 51e. The input/output terminals 51a and 51b may be selectively connectable to the diversity terminal 51f. The diversity terminal 51f is selectively connectable to the antenna terminals 51c and 51d. The diversity terminal 51e may be selectively connectable to the antenna terminals 51c and 51d. Switching of the connection relationship in the antenna switch 51 is performed by a controller, the RFIC 4, or the like.

In the present embodiment, the primary module 2 is implemented on or in a single module substrate. The module substrate of the primary module 2 is a substrate different from a substrate on or in which the diversity module 3 is implemented. The primary module 2 may be a single-packaged module. In this case, the module may include a plurality of substrates.

The module substrate of the primary module 2 is a substrate on or in which circuit elements included in the primary module 2 are implemented. To be specific, the power amplifiers 11 and 12, the low-noise amplifiers 21 and 22, the switches 31a, 31b, and 32, the filters 41a, 41b, and 42, and the antenna switch 51 are implemented on or in the module substrate of the primary module 2. These circuit elements may be implemented on only one of two main surfaces of the module substrate, or may be implemented on both the two main surfaces. The individual external connection terminals of the primary module 2 (to be specific, the antenna connection terminals 101 and 102, the RF input terminals 111 and 112, the RF output terminals 121 and 122, and the diversity connection terminals 131 and 132) are implemented by bump electrodes, planar electrodes or post electrodes, lands connected to bonding wires, or the like provided on or in the module substrate.

The module substrate of the primary module 2 may be, but is not limited to, a low temperature co-fired ceramics (LTCC) substrate, a high temperature co-fired ceramics (HTCC) substrate, a component built-in substrate, a substrate including a redistribution layer (RDL) (for example, an LTCC substrate including an RDL), a printed circuit board, or the like, having a multilayer structure of a plurality of dielectric layers, for example.

The circuit configuration of the primary module 2 is not limited to the example illustrated in FIG. 1. For example, the primary module 2 does not necessarily have to include the low-noise amplifier 21, the low-noise amplifier 22, the switch 31a, the switch 31b, the switch 32, the filter 41a, the filter 41b, the filter 42, the RF output terminal 121, or the RF output terminal 122.

### 1.3 CIRCUIT CONFIGURATION OF DIVERSITY MODULE 3

Next, the circuit configuration of the diversity module 3 will be described.

The diversity module 3 is an example of a second transfer circuit. As illustrated in FIG. 1, the diversity module 3 includes a power amplifier 13, a low-noise amplifier 23, a switch 33, a filter 43, the antenna switch 52, the antenna connection terminals 103 and 104, an RF input terminal 113, an RF output terminal 123, and the primary connection terminals 141 and 142.

The antenna connection terminals 103 and 104, the RF input terminal 113, the RF output terminal 123, and the primary connection terminals 141 and 142 are each an external connection terminal included in the diversity module 3.

The antenna connection terminal 103 is connected to the antenna 5c outside the diversity module 3 and is connected to an antenna terminal 52c of the antenna switch 52 inside the diversity module 3. The antenna connection terminal 104 is connected to the antenna 5d outside the diversity module 3 and is connected to an antenna terminal 52d of the antenna switch 52 inside the diversity module 3.

The RF input terminal 113 is connected to the RFIC 4 outside the diversity module 3 and is connected to an input end of the power amplifier 13 inside the diversity module 3. The RF output terminal 123 is connected to the RFIC 4 outside the diversity module 3 and is connected to an output end of the low-noise amplifier 23 inside the diversity module 3.

The primary connection terminal 141 is connected to the diversity connection terminal 131 of the primary module 2 outside the diversity module 3 and is connected to the primary terminal 52e of the antenna switch 52 inside the diversity module 3. The primary connection terminal 142 is connected to the diversity connection terminal 132 of the primary module 2 outside the diversity module 3 and is connected to the primary terminal 52f of the antenna switch 52 inside the diversity module 3.

The power amplifier 13 is an example of a third power amplifier and is configured to amplify a transmission signal of the second band output from the RFIC 4. The input end of the power amplifier 13 is connected to the RF input terminal 113. An output end of the power amplifier 13 is connected to an input/output terminal 52a of the antenna switch 52 via the switch 33 and the filter 43.

The low-noise amplifier 23 is configured to amplify a reception signal of the second band received by any one of the antennas 5a, 5b, 5c, and 5d. An input end of the low-noise amplifier 23 is connected to the input/output terminal 52a of the antenna switch 52 via the switch 33 and the filter 43. The output end of the low-noise amplifier 23 is connected to the RF output terminal 123.

The switch 33 is a switch for switching a signal to pass through the filter 43 between a transmission signal and a reception signal. That is, the switch 33 is a transmission/reception switching switch (TDD switch) for switching between transmission and reception of a band included in the pass band of the filter 43. To be specific, the switch 33 is an SPDT switch having a common terminal and two selection terminals. The common terminal of the switch 33 is connected to one end of the filter 43. One of the two selection terminals of the switch 33 is connected to the output end of the power amplifier 13. The other of the two selection terminals of the switch 33 is connected to the input end of the low-noise amplifier 23. The number of selection terminals of the switch 33 may be three or more.

The filter 43 is an example of a third filter and is connected between the power amplifier 13 and the input/output terminal 52a of the antenna switch 52. To be specific, the one end of the filter 43 is connected to each of the power amplifier 13 and the low-noise amplifier 23 via the switch 33. The other end of the filter 43 is connected to the input/output terminal 52a of the antenna switch 52.

The filter 43 has a pass band including at least part of band B (second band). Band B is a band for TDD, but is not limited thereto and may be a band for FDD. In this case, a duplexer, instead of the filter 43 and the switch 33, is provided between the input/output terminal 52a and a set of the power amplifier 13 and the low-noise amplifier 23. The duplexer is constituted by a filter having a pass band including an uplink operation band of the band for FDD and a filter having a pass band including a downlink operation band of the band for FDD.

The antenna switch 52 is an example of a second switch circuit and includes the input/output terminal 52a, the antenna terminals 52c and 52d, and the primary terminals 52e and 52f.

The input/output terminal 52a is an example of a third input/output terminal and is connected to the power amplifier 13. To be specific, the input/output terminal 52a is connected to the output end of the power amplifier 13 via the filter 43 and the switch 33.

The antenna terminal 52c is an example of a third antenna terminal and is connected to the antenna 5c via the antenna connection terminal 103. The antenna terminal 52d is an example of a fourth antenna terminal and is connected to the antenna 5d via the antenna connection terminal 104.

The primary terminal 52e is an example of a third inter-module terminal (first primary terminal) and is connected to the diversity terminal 51e of the antenna switch 51 included in the primary module 2. To be specific, the primary terminal 52e is connected to the diversity terminal 51e via the primary connection terminal 141 and the diversity connection terminal 131.

The primary terminal 52f is an example of a fourth inter-module terminal (second primary terminal) and is connected to the diversity terminal 51f of the antenna switch 51 included in the primary module 2. To be specific, the primary terminal 52f is connected to the diversity terminal 51f via the primary connection terminal 142 and the diversity connection terminal 132.

The antenna switch 52 is a multi-connection switch circuit. The input/output terminal 52a is selectively connectable to at least the antenna terminals 52c and 52d and the primary terminal 52f. The input/output terminal 52a may be selectively connectable to the primary terminal 52e. The primary terminal 52e is selectively connectable to the antenna terminals 52c and 52d. The primary terminal 52f may be selectively connectable to the antenna terminals 52c and 52d. Switching of the connection relationship in the antenna switch 52 is performed by a controller, the RFIC 4, or the like.

In the present embodiment, the diversity module 3 is implemented on or in a module substrate different from a substrate on or in which the primary module 2 is implemented. The diversity module 3 may be a single-packaged module. In this case, the module may include a plurality of substrates.

The module substrate of the diversity module 3 is a substrate on or in which circuit elements included in the diversity module 3 are implemented. To be specific, the power amplifier 13, the low-noise amplifier 23, the switch 33, the filter 43, and the antenna switch 52 are implemented on or in the module substrate of the diversity module 3. These circuit elements may be implemented on only one of two main surfaces of the module substrate, or may be implemented on both the two main surfaces. The individual external connection terminals of the diversity module 3 (to be specific, the antenna connection terminals 103 and 104, the RF input terminal 113, the RF output terminal 123, and the primary connection terminals 141 and 142) are implemented by bump electrodes, planar electrodes or post electrodes, lands connected to bonding wires, or the like provided on or in the module substrate.

The module substrate of the diversity module 3 may be, but is not limited to, an LTCC substrate, an HTCC substrate, a component built-in substrate, a substrate including an RDL (for example, an LTCC substrate including an RDL), a printed circuit board, or the like, having a multilayer structure of a plurality of dielectric layers, for example.

The circuit configuration of the diversity module 3 is not limited to the example illustrated in FIG. 1. For example, the diversity module 3 does not necessarily have to include the low-noise amplifier 23, the switch 33, the filter 43, or the RF output terminal 123.

### 1.4 OPERATION EXAMPLES

Hereinafter, specific operation examples of the above-described RF circuit 1 will be described.

In the RF circuit 1, the three input/output terminals 51a, 51b, and 52a are each selectively connectable to the four antenna terminals 51c, 51d, 52c, and 52d. The combination of connections between the three input/output terminals 51a, 51b, and 52a and the four antenna terminals 51c, 51d, 52c, and 52d is controlled by a controller or the RFIC 4. For example, connections can be switched in accordance with the communication statuses, antenna characteristics (sensitivity and radiation quality), or the like of the antennas 5a, 5b, 5c, and 5d. In the RF circuit 1, antennas can be selected highly freely. To be specific, any of the antennas 5a, 5b, 5c, and 5d is selectable in the case of transmitting three transmission signals. This architecture provides a high degree of flexibility routing signals, allowing an RF signal from a given power amplifier to be selectively transmitted from any of a plurality of available antennas. Appropriate antennas can be selected in accordance with a situation, and thus the quality of the transmission signals can be increased.

Hereinafter, a description will be given of an example in which band A is band n28 for 5G-NR and band B is band n41 for 5G-NR (the combination in the top row in Table 1), but the combination of band A and band B is not limited thereto. The combination of band A and band B may be any combination shown in Table 1 or another combination.

### 1.4.1 First Operation Example

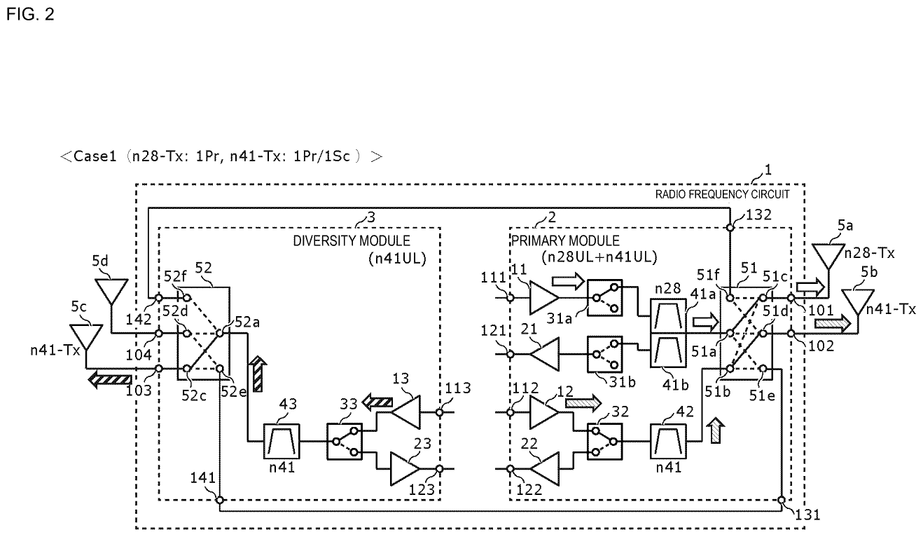

First, a first operation example will be described with reference to FIG. 2. FIG. 2 is a diagram illustrating a first operation example (case 1) of the RF circuit 1 according to the present embodiment.

In the present operation example, the RF circuit 1 outputs a transmission signal of band n28 to one of the antennas 5a and 5b connected to the primary module 2, outputs one of two transmission signals of band n41 to the other of the antennas 5a and 5b connected to the primary module 2, and outputs the other of the two transmission signals of band n41 to one of the antennas 5c and 5d connected to the diversity module 3.

To be specific, in the antenna switch 51, the antenna terminal 51c is connected to the input/output terminal 51a, and the antenna terminal 51d is connected to the input/output terminal 51b, as illustrated in FIG. 2. In this case, in the antenna switch 52, the antenna terminal 52c is connected to the input/output terminal 52a.

Accordingly, the transmission signal of band n28 amplified by the power amplifier 11 is output to the antenna 5a via the switch 31a, the filter 41a, the input/output terminal 51a, the antenna terminal 51c, and the antenna connection terminal 101, and is radiated from the antenna 5a. The transmission signal of band n41 amplified by the power amplifier 12 is output to the antenna 5b via the switch 32, the filter 42, the input/output terminal 51b, the antenna terminal 51d, and the antenna connection terminal 102, and is radiated from the antenna 5b. The transmission signal of band n41 amplified by the power amplifier 13 is output to the antenna 5c via the switch 33, the filter 43, the input/output terminal 52a, the antenna terminal 52c, and the antenna connection terminal 103, and is radiated from the antenna 5c.

Instead of the antenna terminal 52c, the antenna terminal 52d may be connected to the input/output terminal 52a. In this case, the transmission signal of band n41 amplified by the power amplifier 13 is radiated from the antenna 5d. Alternatively, the antenna terminal 51c may be connected to the input/output terminal 51b, and the antenna terminal 51d may be connected to the input/output terminal 51a. In this case, the transmission signal of band n41 amplified by the power amplifier 12 is radiated from the antenna 5a, and the transmission signal of band n28 amplified by the power amplifier 11 is radiated from the antenna 5b.

### 1.4.2 Second Operation Example

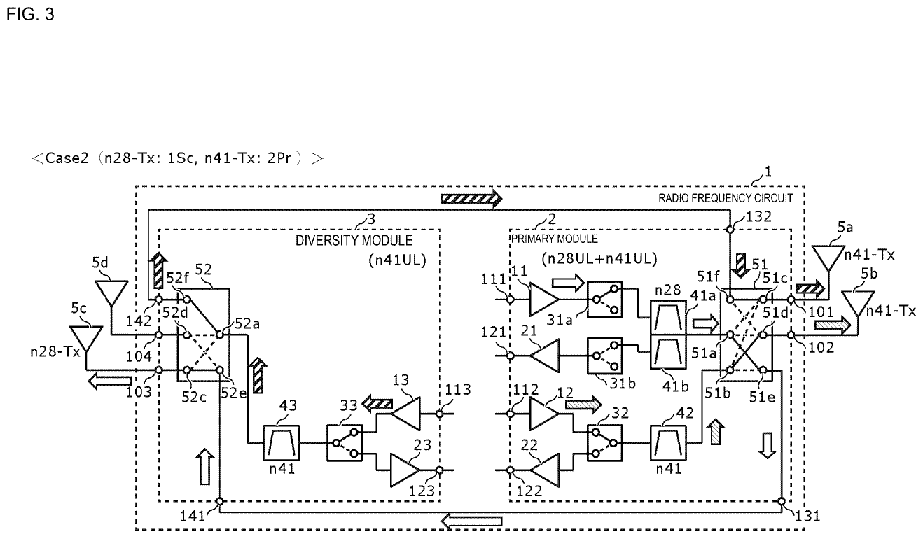

Next, a second operation example will be described with reference to FIG. 3. FIG. 3 is a diagram illustrating a second operation example (case 2) of the RF circuit 1 according to the present embodiment.

In the present operation example, the RF circuit 1 outputs a transmission signal of band n28 to one of the antennas 5c and 5d connected to the diversity module 3, and outputs two transmission signals of band n41 to the antennas 5a and 5b connected to the primary module 2, respectively.

To be specific, in the antenna switch 51, the antenna terminal 51c is connected to the diversity terminal 51f, the antenna terminal 51d is connected to the input/output terminal 51b, and the diversity terminal 51e is connected to the input/output terminal 51a, as illustrated in FIG. 3. In this case, in the antenna switch 52, the antenna terminal 52c is connected to the primary terminal 52e, and the primary terminal 52f is connected to the input/output terminal 52a.

Accordingly, the transmission signal of band n28 amplified by the power amplifier 11 is output to the antenna 5c via the switch 31a, the filter 41a, the input/output terminal 51a, the diversity terminal 51e, the diversity connection terminal 131, the primary connection terminal 141, the primary terminal 52e, the antenna terminal 52c, and the antenna connection terminal 103, and is radiated from the antenna 5c. The transmission signal of band n41 amplified by the power amplifier 12 is output to the antenna 5b via the switch 32, the filter 42, the input/output terminal 51b, the antenna terminal 51d, and the antenna connection terminal 102, and is radiated from the antenna 5b. The transmission signal of band n41 amplified by the power amplifier 13 is output to the antenna 5a via the switch 33, the filter 43, the input/output terminal 52a, the primary terminal 52f, the primary connection terminal 142, the diversity connection terminal 132, the diversity terminal 51f, the antenna terminal 51c, and the antenna connection terminal 101, and is radiated from the antenna 5a.

Instead of the antenna terminal 52c, the antenna terminal 52d may be connected to the primary terminal 52e. In this case, the transmission signal of band n28 amplified by the power amplifier 11 is radiated from the antenna 5d. Alternatively, the antenna terminal 51c may be connected to the input/output terminal 51b, and the antenna terminal 51d may be connected to the diversity terminal 51f. In this case, the transmission signal of band n41 amplified by the power amplifier 12 is radiated from the antenna 5a, and the transmission signal of band n41 amplified by the power amplifier 13 is radiated from the antenna 5b.

### 1.4.3 Third Operation Example

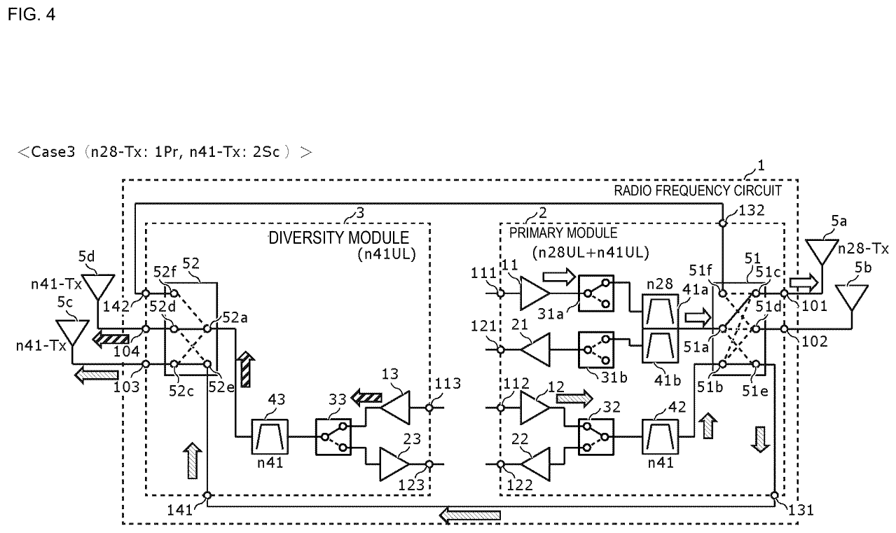

Next, a third operation example will be described with reference to FIG. 4. FIG. 4 is a diagram illustrating a third operation example (case 3) of the RF circuit 1 according to the present embodiment.

In the present operation example, the RF circuit 1 outputs a transmission signal of band n28 to one of the antennas 5a and 5b connected to the primary module 2, and outputs two transmission signals of band n41 to the antennas 5c and 5d connected to the diversity module 3, respectively.

To be specific, in the antenna switch 51, the antenna terminal 51c is connected to the input/output terminal 51a, and the diversity terminal 51e is connected to the input/output terminal 51b, as illustrated in FIG. 4. In this case, in the antenna switch 52, the antenna terminal 52c is connected to the primary terminal 52e, and the antenna terminal 52d is connected to the input/output terminal 52a.

Accordingly, the transmission signal of band n28 amplified by the power amplifier 11 is output to the antenna 5a via the switch 31a, the filter 41a, the input/output terminal 51a, the antenna terminal 51c, and the antenna connection terminal 101, and is radiated from the antenna 5a. The transmission signal of band n41 amplified by the power amplifier 12 is output to the antenna 5c via the switch 32, the filter 42, the input/output terminal 51b, the diversity terminal 51e, the diversity connection terminal 131, the primary connection terminal 141, the primary terminal 52e, the antenna terminal 52c, and the antenna connection terminal 103, and is radiated from the antenna 5c. The transmission signal of band n41 amplified by the power amplifier 13 is output to the antenna 5d via the switch 33, the filter 43, the input/output terminal 52a, the antenna terminal 52d, and the antenna connection terminal 104, and is radiated from the antenna 5d.

Instead of the antenna terminal 51c, the antenna terminal 51d may be connected to the input/output terminal 51a. In this case, the transmission signal of band n28 amplified by the power amplifier 11 is radiated from the antenna 5b. Alternatively, the antenna terminal 52c may be connected to the input/output terminal 52a, and the antenna terminal 52d may be connected to the primary terminal 52e. In this case, the transmission signal of band n41 amplified by the power amplifier 12 is radiated from the antenna 5d, and the transmission signal of band n41 amplified by the power amplifier 13 is radiated from the antenna 5c.

### 1.5 ADVANTAGEOUS EFFECTS AND THE LIKE

As described above, the RF circuit 1 according to the present embodiment includes the primary module 2 (first transfer circuit) including the power amplifiers 11 and 12 and the antenna switch 51; and the diversity module 3 (second transfer circuit) including the power amplifier 13 and the antenna switch 52. The antenna switch 51 includes the input/output terminals 51a and 51b, the antenna terminals 51c and 51d, and the diversity terminals 51e and 51f. The antenna switch 52 includes the input/output terminal 52a, the antenna terminals 52c and 52d, and the primary terminals 52e and 52f. The power amplifier 11 is connected to the input/output terminal 51a. The power amplifier 12 is connected to the input/output terminal 51b. The power amplifier 13 is connected to the input/output terminal 52a. The diversity terminal 51e is connected to the primary terminal 52e. The diversity terminal 51f is connected to the primary terminal 52f. The input/output terminals 51a, 51b, and 52a are each selectively connectable to the antenna terminals 51c, 51d, 52c, and 52d.

Accordingly, the RF circuit 1 that is compact and that reduces deterioration of signal quality during simultaneous transfer can be implemented. To be specific, the three power amplifiers 11, 12, and 13 are disposed in a distributed manner in the two modules, and thus the heat generated from signal amplification can be dispersed. As compared to a case where an RF circuit is constituted by a single module, heat concentration reduces and heat dissipation efficiency increases, and thus a decreased size of the individual modules is realized. The four antennas usable for transmitting RF signals are provided, and thus the antennas can be used by switching therebetween in accordance with, for example, communication statuses, antenna characteristics, or the like. Appropriate antennas can be used in accordance with a situation, and thus deterioration of signal quality can be reduced.

For example, the primary module 2 further includes the filter 41a connected between the power amplifier 11 and the input/output terminal 51a and having a pass band including at least part of a first band; and the filter 42 connected between the power amplifier 12 and the input/output terminal 51b and having a pass band including at least part of a second band. The diversity module 3 further includes the filter 43 connected between the power amplifier 13 and the input/output terminal 52a and having a pass band including at least part of the second band.

Accordingly, the two power amplifiers 12 and 13 each amplify and output a signal of the second band, and thus the gain of each of the power amplifiers 12 and 13 can be reduced even when the maximum output power (power class) of the signal of the second band is high (for example, PC2 or PC1.5). Thus, the amount of heat generated by the power amplifiers 12 and 13 can be reduced, and also signal distortion can be reduced.

For example, as in the first operation example, when the antenna switch 51 is in a state in which one of the antenna terminals 51c and 51d is connected to the input/output terminal 51a, and the other of the antenna terminals 51c and 51d is connected to the input/output terminal 51b, the antenna switch 52 is in a state in which one of the antenna terminals 52c and 52d is connected to the input/output terminal 52a.

Accordingly, the transmission signals amplified by the respective power amplifiers 11 and 12 of the primary module 2 are radiated from the antennas 5a and 5b connected to the primary module 2. For example, disposing the primary module 2 close to the antennas 5a and 5b reduces the lengths of wiring lines through which the transmission signals are transferred, and thus the loss and deterioration of the transmission signals can be reduced. The transmission signal amplified by the power amplifier 13 of the diversity module 3 is radiated from the antenna 5c or 5d connected to the diversity module 3. For example, disposing the diversity module 3 close to the antenna 5c or 5d reduces the length of a wiring line through which the transmission signal is transferred, and thus the loss and deterioration of the transmission signal can be reduced.

For example, as in the second operation example, when the antenna switch 51 is in a state in which one of the antenna terminals 51c and 51d is connected to the diversity terminal 51f, the other of the antenna terminals 51c and 51d is connected to the input/output terminal 51b, and the diversity terminal 51e is connected to the input/output terminal 51a, the antenna switch 52 is in a state in which one of the antenna terminals 52c and 52d is connected to the primary terminal 52e, and the primary terminal 52f is connected to the input/output terminal 52a.

Accordingly, the transmission signal amplified by the power amplifier 11 of the primary module 2 is radiated from the antenna 5c or 5d connected to the diversity module 3. The transmission signal amplified by the power amplifier 13 of the diversity module 3 is radiated from the antenna 5a or 5b connected to the primary module 2. For example, when the communication statuses of the antennas 5a and 5b are favorable and band n41 has higher priority than band n28 (improvement in the quality of the transmission signal of band n41 is requested), the request can be responded to. When the antenna characteristics of the antennas 5a and 5b are more suitable for band n41 than those of the antennas 5c and 5d, the quality of the transmission signal of band n41 can be increased.

For example, as in the third operation example, when the antenna switch 51 is in a state in which one of the antenna terminals 51c and 51d is connected to the input/output terminal 51a, and the diversity terminal 51e is connected to the input/output terminal 51b, the antenna switch 52 is in a state in which one of the antenna terminals 52c and 52d is connected to the input/output terminal 52a, and the other of the antenna terminals 52c and 52d is connected to the primary terminal 52e.

Accordingly, the transmission signal amplified by the power amplifier 12 of the primary module 2 is radiated from one of the antennas 5c and 5d connected to the diversity module 3. The transmission signal amplified by the power amplifier 13 of the diversity module 3 is radiated from the other of the antennas 5c and 5d connected to the diversity module 3. For example, when the communication statuses of the antennas 5c and 5d are favorable and band n41 has higher priority than band n28 (improvement in the quality of the transmission signal of band n41 is requested), the request can be responded to. When the antenna characteristics of the antennas 5c and 5d are more suitable for band n41 than those of the antennas 5a and 5b, the quality of the transmission signal of band n41 can be increased.

For example, the primary module 2 is implemented on or in a substrate, and the diversity module 3 is implemented on or in another substrate.

The communication device 6 according to the present embodiment includes the RF circuit 1, and the RFIC 4 configured to process an RF signal transferred in the RF circuit 1.

Accordingly, the communication device 6 that is compact and that reduces deterioration of signal quality during simultaneous transfer can be implemented.

### Second Embodiment

Next, a second embodiment will be described.

The second embodiment is different from the first embodiment mainly in that the diversity module includes a low-noise amplifier and that the antenna switch of the diversity module includes an input/output terminal connected to the low-noise amplifier. Hereinafter, the differences from the first embodiment will be mainly described, and the description of common features will be omitted or simplified.

### 2.1 CIRCUIT CONFIGURATION OF RF CIRCUIT 1A

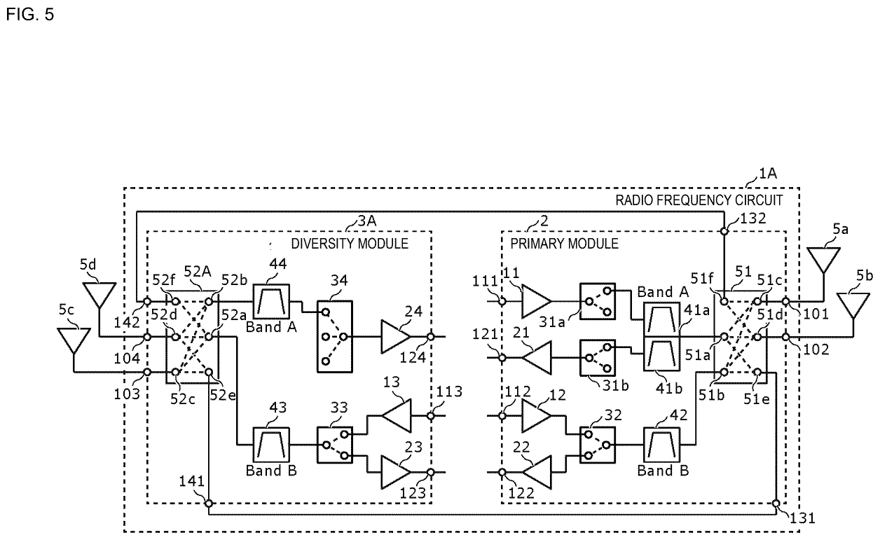

The circuit configuration of an RF circuit 1A according to the present embodiment will be described with reference to FIG. 5. FIG. 5 is a circuit configuration diagram of the RF circuit 1A according to the present embodiment.

FIG. 5 illustrates an exemplary circuit configuration. The RF circuit 1A can be implemented by using any of a wide variety of circuit implementations and circuit techniques. Thus, the description of the RF circuit 1A provided below is not to be construed in a limiting manner.

The communication device according to the present embodiment is similar to the communication device 6 according to the first embodiment except that the RF circuit 1A is included instead of the RF circuit 1, and thus the illustration and description thereof is omitted.

As illustrated in FIG. 5, the RF circuit 1A is the same as the RF circuit 1 according to the first embodiment except that a diversity module 3A is included instead of the diversity module 3.

### 2.2 CIRCUIT CONFIGURATION OF DIVERSITY MODULE 3A

Next, the circuit configuration of the diversity module 3A will be described.

The diversity module 3A is an example of a second transfer circuit. As illustrated in FIG. 5, the diversity module 3A is different from the diversity module 3 in including an antenna switch 52A instead of the antenna switch 52. In addition, the diversity module 3A includes a low-noise amplifier 24, a switch 34, a filter 44, and an RF output terminal 124.

The RF output terminal 124 is connected to the RFIC 4 outside the diversity module 3A and is connected to an output end of the low-noise amplifier 24 inside the diversity module 3A.

The low-noise amplifier 24 is an example of a low-noise amplifier included in the second transfer circuit. In the present embodiment, the low-noise amplifier 24 is configured to amplify a reception signal of the first band received by any one of the antennas 5a, 5b, 5c, and 5d. An input end of the low-noise amplifier 24 is connected to an input/output terminal 52b of the antenna switch 52A via the switch 34 and the filter 44. The output end of the low-noise amplifier 24 is connected to the RF output terminal 124.

The switch 34 is a switch for switching a transfer source of a reception signal to be input to the low-noise amplifier 24. To be specific, the switch 34 is a single-pole triple-throw (SP3T) switch having a common terminal and three selection terminals. The common terminal of the switch 34 is connected to the input end of the low-noise amplifier 24. One of the three selection terminals of the switch 34 is connected to an output end of the filter 44. The other two of the three selection terminals of the switch 34 are each connected to, for example, an output end of a filter. The number of selection terminals of the switch 34 may be two or may be four or more.

The filter 44 is an example of a fourth filter and is connected between the low-noise amplifier 24 and the input/output terminal 52b of the antenna switch 52A. To be specific, an input end of the filter 44 is connected to the input/output terminal 52b of the antenna switch 52A. The output end of the filter 44 is connected to the low-noise amplifier 24 via the switch 34.

The filter 44 has a pass band including at least part of band A (first band). To be specific, the filter 44 has a pass band including a downlink operation band of band A.

The antenna switch 52A is an example of a second switch circuit and includes the input/output terminal 52b in addition to the configuration of the antenna switch 52.

The input/output terminal 52b is an example of a fourth input/output terminal and is connected to the low-noise amplifier 24. To be specific, the input/output terminal 52b is connected to the input end of the low-noise amplifier 24 via the filter 44 and the switch 34.

The antenna switch 52A is a multi-connection switch circuit. The input/output terminals 52a and 52b are each selectively connectable to at least the antenna terminals 52c and 52d and the primary terminal 52f. The input/output terminals 52a and 52b may each be selectively connectable to the primary terminal 52e. The primary terminal 52e is selectively connectable to the antenna terminals 52c and 52d. The primary terminal 52f may be selectively connectable to the antenna terminals 52c and 52d. Switching of the connection relationship in the antenna switch 52A is performed by a controller, the RFIC 4, or the like.

In the present embodiment, the diversity module 3A is implemented on or in a module substrate different from a substrate on or in which the primary module 2 is implemented. The diversity module 3A may be a single-packaged module. In this case, the module may include a plurality of substrates.

The circuit configuration of the diversity module 3A is not limited to the example illustrated in FIG. 5. For example, the diversity module 3A does not necessarily have to include the low-noise amplifier 23, the switch 33, the filter 43, or the RF output terminal 123.

### 2.3 OPERATION EXAMPLES

Hereinafter, specific operation examples of the above-described RF circuit 1A will be described.

In the RF circuit 1A, the four input/output terminals 51a, 51b, 52a, and 52b are each selectively connectable to the four antenna terminals 51c, 51d, 52c, and 52d. The combination of connections between the four input/output terminals 51a, 51b, 52a, and 52b and the four antenna terminals 51c, 51d, 52c, and 52d is controlled by a controller or the RFIC 4. For example, connections can be switched in accordance with the communication statuses, antenna characteristics (sensitivity and radiation quality), or the like of the antennas 5a, 5b, 5c, and 5d. In the RF circuit 1A, antennas can be selected highly freely. To be specific, any of the antennas 5a, 5b, 5c, and 5d is selectable in the case of receiving one reception signal. For example, an antenna can be selected by placing priority on reception of a reception signal, and three transmission signals can be transmitted by using the three other antennas. Alternatively, priority can be placed on transmission of at least one transmission signal among three transmission signals. In this way, appropriate antennas can be selected in accordance with a situation, and thus the quality of a reception signal and/or a transmission signal can be increased.

Hereinafter, a description will be given of an example in which band A is band n28 for 5G-NR and band B is band n41 for 5G-NR (the combination in the top row in Table 1), but the combination of band A and band B is not limited thereto. The combination of band A and band B may be any combination shown in Table 1 or another combination.

### 2.3.1 First Operation Example

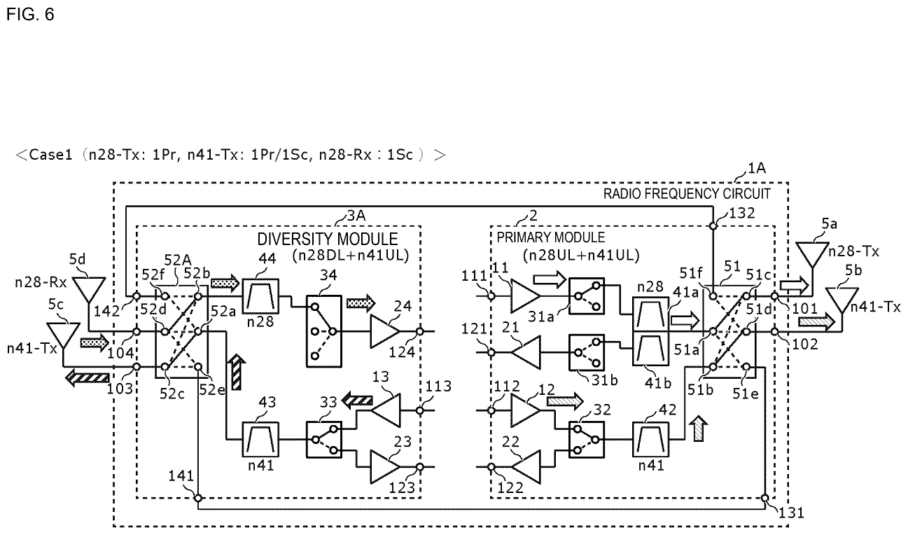

First, a first operation example will be described with reference to FIG. 6. FIG. 6 is a diagram illustrating a first operation example (case 1) of the RF circuit 1A according to the present embodiment.

In the present operation example, the RF circuit 1A outputs a transmission signal of band n28 to one of the antennas 5a and 5b connected to the primary module 2, outputs one of two transmission signals of band n41 to the other of the antennas 5a and 5b connected to the primary module 2, outputs the other of the two transmission signals of band n41 to one of the antennas 5c and 5d connected to the diversity module 3A, and receives a reception signal of band n28 from the other of the antennas 5c and 5d connected to the diversity module 3A.

To be specific, in the antenna switch 51, the antenna terminal 51c is connected to the input/output terminal 51a, and the antenna terminal 51d is connected to the input/output terminal 51b, as illustrated in FIG. 6. In this case, in the antenna switch 52A, the antenna terminal 52c is connected to the input/output terminal 52a, and the antenna terminal 52d is connected to the input/output terminal 52b.

Accordingly, the transmission signal of band n28 amplified by the power amplifier 11 is output to the antenna 5a via the switch 31a, the filter 41a, the input/output terminal 51a, the antenna terminal 51c, and the antenna connection terminal 101, and is radiated from the antenna 5a. The transmission signal of band n41 amplified by the power amplifier 12 is output to the antenna 5b via the switch 32, the filter 42, the input/output terminal 51b, the antenna terminal 51d, and the antenna connection terminal 102, and is radiated from the antenna 5b. The transmission signal of band n41 amplified by the power amplifier 13 is output to the antenna 5c via the switch 33, the filter 43, the input/output terminal 52a, the antenna terminal 52c, and the antenna connection terminal 103, and is radiated from the antenna 5c. The reception signal received by the antenna 5d is input to the low-noise amplifier 24 via the antenna connection terminal 104, the antenna terminal 52d, the input/output terminal 52b, the filter 44, and the switch 34.

Alternatively, the antenna terminal 52d may be connected to the input/output terminal 52a, and the antenna terminal 52c may be connected to the input/output terminal 52b. In this case, the transmission signal of band n41 amplified by the power amplifier 13 is radiated from the antenna 5d, and the reception signal of band n28 received by the antenna 5c is input to the low-noise amplifier 24. Alternatively, the antenna terminal 51c may be connected to the input/output terminal 51b, and the antenna terminal 51d may be connected to the input/output terminal 51a. In this case, the transmission signal of band n41 amplified by the power amplifier 12 is radiated from the antenna 5a, and the transmission signal of band n28 amplified by the power amplifier 11 is radiated from the antenna 5b.

### 2.3.2 Second Operation Example

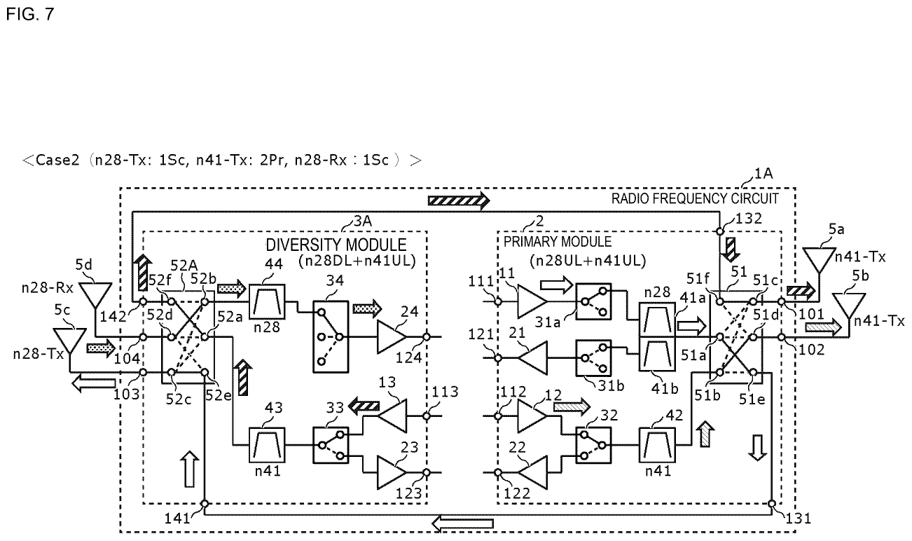

Next, a second operation example will be described with reference to FIG. 7. FIG. 7 is a diagram illustrating a second operation example (case 2) of the RF circuit 1A according to the present embodiment.

In the present operation example, the RF circuit 1A outputs a transmission signal of band n28 to one of the antennas 5c and 5d connected to the diversity module 3A, outputs two transmission signals of band n41 to the antennas 5a and 5b connected to the primary module 2, respectively, and receives a reception signal of band n28 from the other of the antennas 5c and 5d connected to the diversity module 3A.

To be specific, in the antenna switch 51, the antenna terminal 51c is connected to the diversity terminal 51f, the antenna terminal 51d is connected to the input/output terminal 51b, and the diversity terminal 51e is connected to the input/output terminal 51a, as illustrated in FIG. 7. In this case, in the antenna switch 52A, the antenna terminal 52c is connected to the primary terminal 52e, the antenna terminal 52d is connected to the input/output terminal 52b, and the primary terminal 52f is connected to the input/output terminal 52a.

Accordingly, the transmission signal of band n28 amplified by the power amplifier 11 is output to the antenna 5c via the switch 31a, the filter 41a, the input/output terminal 51a, the diversity terminal 51e, the diversity connection terminal 131, the primary connection terminal 141, the primary terminal 52e, the antenna terminal 52c, and the antenna connection terminal 103, and is radiated from the antenna 5c. The transmission signal of band n41 amplified by the power amplifier 12 is output to the antenna 5b via the switch 32, the filter 42, the input/output terminal 51b, the antenna terminal 51d, and the antenna connection terminal 102, and is radiated from the antenna 5b. The transmission signal of band n41 amplified by the power amplifier 13 is output to the antenna 5a via the switch 33, the filter 43, the input/output terminal 52a, the primary terminal 52f, the primary connection terminal 142, the diversity connection terminal 132, the diversity terminal 51f, the antenna terminal 51c, and the antenna connection terminal 101, and is radiated from the antenna 5a. The reception signal received by the antenna 5d is input to the low-noise amplifier 24 via the antenna connection terminal 104, the antenna terminal 52d, the input/output terminal 52b, the filter 44, and the switch 34.

Alternatively, the antenna terminal 52d may be connected to the primary terminal 52e, and the antenna terminal 52c may be connected to the input/output terminal 52b. In this case, the transmission signal of band n28 amplified by the power amplifier 11 is radiated from the antenna 5d, and the reception signal of band n28 received by the antenna 5c is input to the low-noise amplifier 24. Alternatively, the antenna terminal 51c may be connected to the input/output terminal 51b, and the antenna terminal 51d may be connected to the diversity terminal 51f. In this case, the transmission signal of band n41 amplified by the power amplifier 12 is radiated from the antenna 5a, and the transmission signal of band n41 amplified by the power amplifier 13 is radiated from the antenna 5b.

### 2.3.3 Third Operation Example

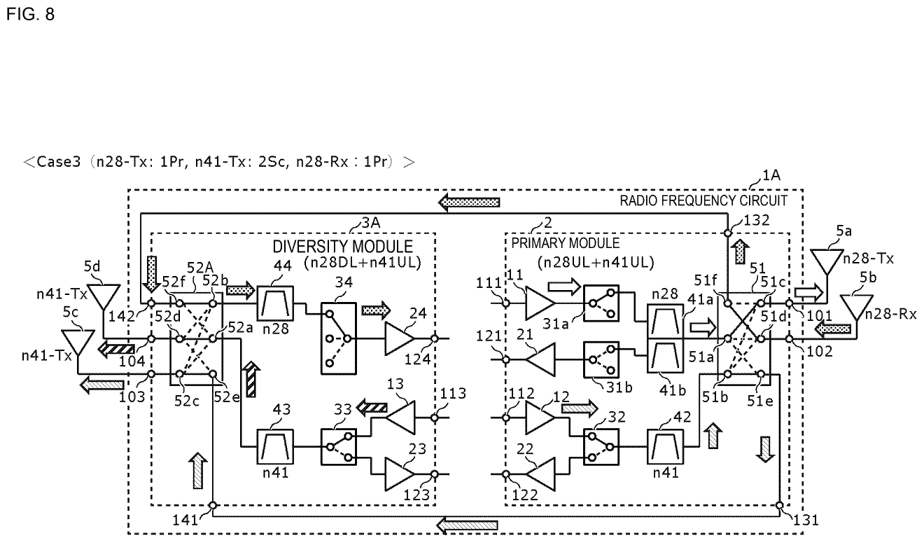

Next, a third operation example will be described with reference to FIG. 8. FIG. 8 is a diagram illustrating a third operation example (case 3) of the RF circuit 1A according to the present embodiment.

In the present operation example, the RF circuit 1A outputs a transmission signal of band n28 to one of the antennas 5a and 5b connected to the primary module 2, outputs two transmission signals of band n41 to the antennas 5c and 5d connected to the diversity module 3A, respectively, and receives a reception signal of band n28 from the other of the antennas 5a and 5b connected to the primary module 2.

To be specific, in the antenna switch 51, the antenna terminal 51c is connected to the input/output terminal 51a, the antenna terminal 51d is connected to the diversity terminal 51f, and the diversity terminal 51e is connected to the input/output terminal 51b, as illustrated in FIG. 8. In this case, in the antenna switch 52A, the antenna terminal 52c is connected to the primary terminal 52e, the antenna terminal 52d is connected to the input/output terminal 52a, and the primary terminal 52f is connected to the input/output terminal 52b.

Accordingly, the transmission signal of band n28 amplified by the power amplifier 11 is output to the antenna 5a via the switch 31a, the filter 41a, the input/output terminal 51a, the antenna terminal 51c, and the antenna connection terminal 101, and is radiated from the antenna 5a. The transmission signal of band n41 amplified by the power amplifier 12 is output to the antenna 5c via the switch 32, the filter 42, the input/output terminal 51b, the diversity terminal 51e, the diversity connection terminal 131, the primary connection terminal 141, the primary terminal 52e, the antenna terminal 52c, and the antenna connection terminal 103, and is radiated from the antenna 5c. The transmission signal of band n41 amplified by the power amplifier 13 is output to the antenna 5d via the switch 33, the filter 43, the input/output terminal 52a, the antenna terminal 52d, and the antenna connection terminal 104, and is radiated from the antenna 5d. The reception signal received by the antenna 5b is input to the low-noise amplifier 24 via the antenna connection terminal 102, the antenna terminal 51d, the diversity terminal 51f, the diversity connection terminal 132, the primary connection terminal 142, the primary terminal 52f, the input/output terminal 52b, the filter 44, and the switch 34.

Alternatively, the antenna terminal 51d may be connected to the input/output terminal 51a, and the antenna terminal 51c may be connected to the diversity terminal 51f. In this case, the transmission signal of band n28 amplified by the power amplifier 11 is radiated from the antenna 5b, and the reception signal of band n28 received by the antenna 5a is input to the low-noise amplifier 24. Alternatively, the antenna terminal 52c may be connected to the input/output terminal 52a, and the antenna terminal 52d may be connected to the primary terminal 52e. In this case, the transmission signal of band n41 amplified by the power amplifier 12 is radiated from the antenna 5d, and the transmission signal of band n41 amplified by the power amplifier 13 is radiated from the antenna 5c.

### 2.4 ADVANTAGEOUS EFFECTS AND THE LIKE

As described above, in the RF circuit 1A according to the present embodiment, the diversity module 3A (second transfer circuit) further includes the low-noise amplifier 24, the antenna switch 52A includes the input/output terminal 52b connected to the low-noise amplifier 24, and the input/output terminal 52b is connectable to the antenna terminals 51c, 51d, 52c, and 52d.

Accordingly, the RF circuit 1A that is compact and that reduces deterioration of signal quality during simultaneous transmission and reception can be implemented. To be specific, the three power amplifiers 11, 12, and 13 and the low-noise amplifier 24 are disposed in a distributed manner in the two modules, and thus the heat generated from signal amplification can be dispersed. As compared to a case where an RF circuit is constituted by a single module, heat concentration reduces and heat dissipation efficiency increases, and thus a decreased size of the individual modules is realized. The four antennas usable for transmitting and receiving RF signals are provided, and thus the antennas can be used by switching therebetween in accordance with, for example, communication statuses or the like. Appropriate antennas can be used in accordance with a situation, and thus deterioration of signal quality can be reduced. For example, an optimal antenna can be used for reception with priority placed on reception of a signal, and thus a transmission signal can be transmitted while the quality of a reception signal is increased.

For example, the primary module 2 further includes the filter 41a connected between the power amplifier 11 and the input/output terminal 51a and having a pass band including at least part of a first band, and the filter 42 connected between the power amplifier 12 and the input/output terminal 51b and having a pass band including at least part of a second band. The diversity module 3A further includes the filter 43 connected between the power amplifier 13 and the input/output terminal 52a and having a pass band including at least part of the second band, and the filter 44 connected between the low-noise amplifier 24 and the input/output terminal 52b and having a pass band including at least part of the first band.

Accordingly, the two power amplifiers 12 and 13 each amplify and output a signal of the second band, and thus the gain of each of the power amplifiers 12 and 13 can be reduced even when the maximum output power (power class) of the signal of the second band is high (for example, PC2 or PC1.5). Thus, the amount of heat generated by the power amplifiers 12 and 13 can be reduced, and also signal distortion can be reduced.

For example, as in the first operation example, when the antenna switch 51 is in a state in which one of the antenna terminals 51c and 51d is connected to the first input/output terminal 51a, and the other of the antenna terminals 51c and 51d is connected to the input/output terminal 51b, the antenna switch 52A is in a state in which one of the antenna terminals 52c and 52d is connected to the input/output terminal 52a, and the other of the antenna terminals 52c and 52d is connected to the input/output terminal 52b.

Accordingly, the transmission signals amplified by the respective power amplifiers 11 and 12 of the primary module 2 are radiated from the antennas 5a and 5b connected to the primary module 2. For example, disposing the primary module 2 close to the antennas 5a and 5b reduces the lengths of wiring lines through which the transmission signals are transferred, and thus the loss and deterioration of the transmission signals can be reduced. The transmission signal amplified by the power amplifier 13 of the diversity module 3A is radiated from the antenna 5c or 5d connected to the diversity module 3A. The reception signal received by the antenna 5c or 5d connected to the diversity module 3A is amplified by the low-noise amplifier 24 of the diversity module 3A. For example, disposing the diversity module 3A close to the antennas 5c and 5d reduces the lengths of wiring lines through which the transmission signal and the reception signal are transferred, and thus the loss and deterioration of the transmission signal and the reception signal can be reduced.

For example, as in the second operation example, when the antenna switch 51 is in a state in which one of the antenna terminals 51c and 51d is connected to the diversity terminal 51f, the other of the antenna terminals 51c and 51d is connected to the input/output terminal 51b, and the diversity terminal 51e is connected to the input/output terminal 51a, the antenna switch 52A is in a state in which one of the antenna terminals 52c and 52d is connected to the primary terminal 52e, the other of the antenna terminals 52c and 52d is connected to the input/output terminal 52b, and the primary terminal 52f is connected to the input/output terminal 52a.

Accordingly, the reception signal to be input to the low-noise amplifier 24 of the diversity module 3A is received by the antenna 5c or 5d connected to the diversity module 3A. For example, when the communication status of the antenna 5c or 5d is favorable and the quality of a reception signal has higher priority than the quality of a transmission signal, the priority can be fulfilled. When the antenna characteristics of the antennas 5a and 5b are more suitable for band n41 than those of the antennas 5c and 5d, the quality of the transmission signal of band n41 can be increased.

For example, as in the third operation example, when the antenna switch 51 is in a state in which one of the antenna terminals 51c and 51d is connected to the input/output terminal 51a, the other of the antenna terminals 51c and 51d is connected to the diversity terminal 51f, and the diversity terminal 51e is connected to the input/output terminal 51b, the antenna switch 52A is in a state in which one of the antenna terminals 52c and 52d is connected to the input/output terminal 52a, the other of the antenna terminals 52c and 52d is connected to the primary terminal 52e, and the primary terminal 52f is connected to the input/output terminal 52b.

Accordingly, the reception signal to be input to the low-noise amplifier 24 of the diversity module 3A is received by the antenna 5a or 5b connected to the primary module 2. For example, when the communication statuses of the antennas 5a and 5b are favorable and the quality of a reception signal has higher priority than the quality of a transmission signal, the priority can be fulfilled. When the antenna characteristics of the antennas 5c and 5d are more suitable for band n41 than those of the antennas 5a and 5b, the quality of the transmission signal of band n41 can be increased.

In the present embodiment, three operation examples have been described with reference to FIG. 6 to FIG. 8, but the operation examples of the RF circuit 1A are not limited thereto. For example, the antenna for receiving a reception signal to be input to the low-noise amplifier 24 of the diversity module 3A may be the same as the antenna for transmitting a transmission signal amplified by any one of the power amplifiers 11, 12, and 13. In other words, one of the antennas 5a, 5b, 5c, and 5d may be used for simultaneous transmission and reception.

### Third Embodiment

Next, a third embodiment will be described.

The third embodiment is different from the second embodiment mainly in that the primary module and the diversity module are each constituted by two modules and that a plurality of diplexers are included. Hereinafter, the differences from the second embodiment will be mainly described, and the description of common features will be omitted or simplified.

### 3.1 CIRCUIT CONFIGURATION OF RF CIRCUIT 1B

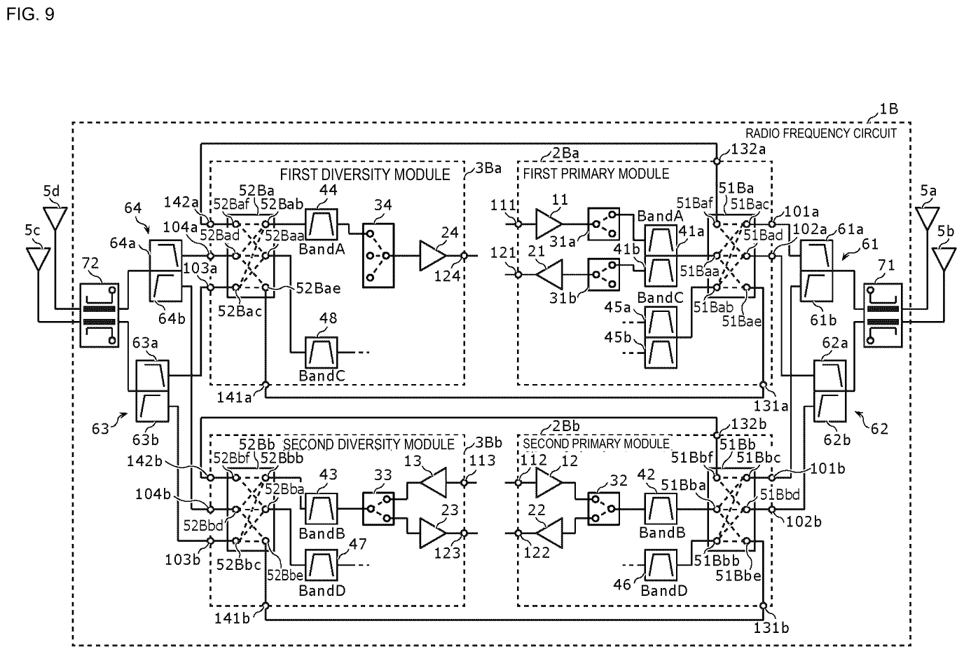

The circuit configuration of an RF circuit 1B according to the present embodiment will be described with reference to FIG. 9. FIG. 9 is a circuit configuration diagram of the RF circuit 1B according to the present embodiment.

FIG. 9 illustrates an exemplary circuit configuration. The RF circuit 1B can be implemented by using any of a wide variety of circuit implementations and circuit techniques. Thus, the description of the RF circuit 1B provided below is not to be construed in a limiting manner.

The communication device according to the present embodiment is similar to the communication device 6 according to the first embodiment except that the RF circuit 1B is included instead of the RF circuit 1, and thus the illustration and description thereof is omitted.

As illustrated in FIG. 9, the RF circuit 1B includes a first primary module 2Ba, a second primary module 2Bb, a first diversity module 3Ba, and a second diversity module 3Bb. The RF circuit 1B also includes diplexers 61, 62, 63, and 64 and couplers 71 and 72.

The first primary module 2Ba and the second primary module 2Bb are each part of an example of a first transfer circuit. To be specific, an example of the first transfer circuit is constituted by the first primary module 2Ba and the second primary module 2Bb. The specific circuit configurations of the first primary module 2Ba and the second primary module 2Bb will be described below.

The first diversity module 3Ba and the second diversity module 3Bb are each part of an example of a second transfer circuit. To be specific, an example of the second transfer circuit is constituted by the first diversity module 3Ba and the second diversity module 3Bb. The specific circuit configurations of the first diversity module 3Ba and the second diversity module 3Bb will be described below.

The diplexer 61 is an example of a first multiplexer and is connected to an antenna terminal 51Bac included in an antenna switch 51Ba of the first primary module 2Ba, an antenna terminal 51Bbc included an antenna switch 51Bb of the second primary module 2Bb, and the antenna 5a. To be specific, the diplexer 61 includes filters 61a and 61b.

The filter 61a is connected between the antenna terminal 51Bac of the antenna switch 51Ba and the antenna 5a. To be specific, one end of the filter 61a is connected to the antenna terminal 51Bac via an antenna connection terminal 101a. The other end of the filter 61a is connected to the antenna 5a via the coupler 71.

The filter 61b is connected between the antenna terminal 51Bbc of the antenna switch 51Bb and the antenna 5a. To be specific, one end of the filter 61b is connected to the antenna terminal 51Bbc via an antenna connection terminal 101b. The other end of the filter 61b is connected to the antenna 5a via the coupler 71.

The diplexer 62 is an example of a second multiplexer and is connected to an antenna terminal 51Bad included in the antenna switch 51Ba of the first primary module 2Ba, an antenna terminal 51Bbd included in the antenna switch 51Bb of the second primary module 2Bb, and the antenna 5b. To be specific, the diplexer 62 includes filters 62a and 62b.

The filter 62a is connected between the antenna terminal 51Bad of the antenna switch 51Ba and the antenna 5b. To be specific, one end of the filter 62a is connected to the antenna terminal 51Bad via an antenna connection terminal 102a. The other end of the filter 62a is connected to the antenna 5b via the coupler 71.

The filter 62b is connected between the antenna terminal 51Bbd of the antenna switch 51Bb and the antenna 5b. To be specific, one end of the filter 62b is connected to the antenna terminal 51Bbd via an antenna connection terminal 102b. The other end of the filter 62b is connected to the antenna 5b via the coupler 71.

The diplexer 63 is an example of a third multiplexer and is connected to an antenna terminal 52Bac included in an antenna switch 52Ba of the first diversity module 3Ba, an antenna terminal 52Bbc included an antenna switch 52Bb of the second diversity module 3Bb, and the antenna 5c. To be specific, the diplexer 63 includes filters 63a and 63b.

The filter 63a is connected between the antenna terminal 52Bac of the antenna switch 52Ba and the antenna 5c. To be specific, one end of the filter 63a is connected to the antenna terminal 52Bac via an antenna connection terminal 103a. The other end of the filter 63a is connected to the antenna 5c via the coupler 72.

The filter 63b is connected between the antenna terminal 52Bbc of the antenna switch 52Bb and the antenna 5c. To be specific, one end of the filter 63b is connected to the antenna terminal 52Bbc via an antenna connection terminal 103b. The other end of the filter 63b is connected to the antenna 5c via the coupler 72.

The diplexer 64 is an example of a fourth multiplexer and is connected to an antenna terminal 52Bad included in the antenna switch 52Ba of the first diversity module 3Ba, an antenna terminal 52Bbd included the antenna switch 52Bb of the second diversity module 3Bb, and the antenna 5d. To be specific, the diplexer 64 includes filters 64a and 64b.

The filter 64a is connected between the antenna terminal 52Bad of the antenna switch 52Ba and the antenna 5d. To be specific, one end of the filter 64a is connected to the antenna terminal 52Bad via an antenna connection terminal 104a. The other end of the filter 64a is connected to the antenna 5d via the coupler 72.

The filter 64b is connected between the antenna terminal 52Bbd of the antenna switch 52Bb and the antenna 5d. To be specific, one end of the filter 64b is connected to the antenna terminal 52Bbd via an antenna connection terminal 104b. The other end of the filter 64b is connected to the antenna 5d via the coupler 72.

The filters 61a, 62a, 63a, and 64a each have, for example, at least part of a low band as a pass band. The low band is a frequency band group constituted by a plurality of communication bands compatible with LTE or 5G-NR and has, for example, a frequency range of 600 MHz to 1000 MHz. The filters 61a, 62a, 63a, and 64a are each a low pass filter, but may each be a band pass filter.

The filters 61b, 62b, 63b, and 64b each have, for example, at least part of a high band as a pass band. The high band is a frequency band group constituted by a plurality of communication bands compatible with LTE or 5G-NR and has, for example, a frequency range of 2.4 GHz to 2.8 GHz. The filters 61b, 62b, 63b, and 64b are each a high pass filter, but may each be a band pass filter.

The filters 61a, 62a, 63a, and 64a may each have, for example, at least part of a middle band (mid-band) as a pass band. Alternatively, the filters 61b, 62b, 63b, and 64b may each have, for example, at least part of a middle band as a pass band. The middle band is a frequency band group constituted by a plurality of communication bands compatible with LTE or 5G-NR and has, for example, a frequency range of 1.5 GHZ to 2.2 GHZ.

The couplers 71 and 72 are each provided for detection. The coupler 71 is provided for detecting a signal that is to be transmitted from the antenna 5a or 5b or that has been received by the antenna 5a or 5b. The coupler 72 is provided for detecting a signal that is to be transmitted from the antenna 5c or 5d or that has been received by the antenna 5c or 5d.

The coupler 71 includes two main lines and two sub-lines coupled to the two respective main lines. One of the two main lines of the coupler 71 is connected between the antenna 5a and the diplexer 61. The other of the two main lines of the coupler 71 is connected between the antenna 5b and the diplexer 62. The two sub-lines of the coupler 71 are each connected to a detector. The two main lines of the coupler 71 are not coupled to each other.

The coupler 72 includes two main lines and two sub-lines coupled to the two respective main lines. One of the two main lines of the coupler 72 is connected between the antenna 5c and the diplexer 63. The other of the two main lines of the coupler 72 is connected between the antenna 5d and the diplexer 64. The two sub-lines of the coupler 72 are each connected to a detector. The two main lines of the coupler 72 are not coupled to each other.

The configuration of the RF circuit 1B is not limited to the example illustrated in FIG. 9. For example, the RF circuit 1B does not necessarily have to include the coupler 71 or 72. The RF circuit 1B does not necessarily have to include the diplexer 61, 62, 63, or 64.

### 3.2 CIRCUIT CONFIGURATION OF FIRST PRIMARY MODULE 2Ba

Next, the circuit configuration of the first primary module 2Ba will be described.

As illustrated in FIG. 9, the first primary module 2Ba includes the power amplifier 11, the low-noise amplifier 21, the switches 31a and 31b, the filters 41a and 41b, filters 45a and 45b, the antenna switch 51Ba, the antenna connection terminals 101a and 102a, the RF input terminal 111, the RF output terminal 121, and diversity connection terminals 131a and 132a.

The antenna connection terminal 101a is connected to the antenna 5a outside the first primary module 2Ba and is connected to the antenna terminal 51Bac of the antenna switch 51Ba inside the first primary module 2Ba. To be specific, the antenna connection terminal 101a is connected to the antenna 5a via the filter 61a and the coupler 71.

The antenna connection terminal 102a is connected to the antenna 5b outside the first primary module 2Ba and is connected to the antenna terminal 51Bad of the antenna switch 51Ba inside the first primary module 2Ba. To be specific, the antenna connection terminal 102a is connected to the antenna 5b via the filter 62a and the coupler 71.

The diversity connection terminal 131a is connected to a primary connection terminal 141a of the first diversity module 3Ba outside the first primary module 2Ba and is connected to a diversity terminal 51Bae of the antenna switch 51Ba inside the first primary module 2Ba.

The diversity connection terminal 132a is connected to a primary connection terminal 142a of the first diversity module 3Ba outside the first primary module 2Ba and is connected to a diversity terminal 51Baf of the antenna switch 51Ba inside the first primary module 2Ba.

The filter 45a is connected, for example, between a power amplifier and an input/output terminal 51Bab of the antenna switch 51Ba. The filter 45b is connected, for example, between a low-noise amplifier and the input/output terminal 51Bab of the antenna switch 51Ba.

The filters 45a and 45b constitute a duplexer. The filters 45a and 45b each have a pass band including at least part of band C (third band). For example, the filter 45a has a pass band including an uplink operation band of band C. The filter 45b has a pass band including a downlink operation band of band C. Band A is a band for FDD, but is not limited thereto and may be a band for TDD.

The antenna switch 51Ba is an example of a first switch included in a first switch circuit and includes input/output terminals 51Baa and 51Bab, the antenna terminals 51Bac and 51Bad, and the diversity terminals 51Bae and 51Baf. In the present embodiment, the first switch circuit includes at least two first antenna terminals, at least two second antenna terminals, at least two first terminals (first diversity terminals), and at least two second terminals (second diversity terminals).

The input/output terminal 51Baa is an example of a first input/output terminal and is connected to the power amplifier 11. To be specific, the input/output terminal 51Baa is connected to the output end of the power amplifier 11 via the filter 41a and the switch 31a.

The input/output terminal 51Bab is connected to the filters 45a and 45b. The input/output terminal 51Bab does not necessarily have to be provided.

The antenna terminal 51Bac is an example of one of the two first antenna terminals and is connected to the antenna 5a. To be specific, the antenna terminal 51Bac is connected to the antenna 5a via the antenna connection terminal 101a, the filter 61a, and the coupler 71.

The antenna terminal 51Bad is an example of one of the two second antenna terminals and is connected to the antenna 5b. To be specific, the antenna terminal 51Bad is connected to the antenna 5b via the antenna connection terminal 102a, the filter 62a, and the coupler 71.

The diversity terminal 51Bae is an example of one of the two first terminals (first diversity terminals) and is connected to a primary terminal 52Bae of the antenna switch 52Ba included in the first diversity module 3Ba. To be specific, the diversity terminal 51Bae is connected to the primary terminal 52Bae via the diversity connection terminal 131a and the primary connection terminal 141a.

The diversity terminal 51Baf is an example of one of the two second terminals (second diversity terminals) and is connected to a primary terminal 52Baf of the antenna switch 52Ba included in the first diversity module 3Ba. To be specific, the diversity terminal 51Baf is connected to the primary terminal 52Baf via the diversity connection terminal 132a and the primary connection terminal 142a.

The antenna switch 51Ba is a multi-connection switch circuit. The input/output terminals 51Baa and 51Bab are each selectively connectable to at least the antenna terminals 51Bac and 51Bad and the diversity terminal 51Bae. The input/output terminals 51Baa and 51Bab may be selectively connectable to the diversity terminal 51Baf. The diversity terminal 51Baf is selectively connectable to the antenna terminals 51Bac and 51Bad. The diversity terminal 51Bae may be selectively connectable to the antenna terminals 51Bac and 51Bad. Switching of the connection relationship in the antenna switch 51Ba is performed by a controller, the RFIC 4, or the like.

In the present embodiment, the first primary module 2Ba is implemented on or in a first module substrate. The first primary module 2Ba may be a single-packaged module. In this case, the module may include a plurality of substrates.

The first module substrate is a substrate on or in which circuit elements included in the first primary module 2Ba are implemented. To be specific, the power amplifier 11 and the antenna switch 51Ba are implemented on or in the first module substrate. In addition, the low-noise amplifier 21, the switches 31a and 31b, and the filters 41a, 41b, 45a, and 45b are implemented on or in the first module substrate. These circuit elements may be implemented on only one of two main surfaces of the first module substrate, or may be implemented on both the two main surfaces. The individual external connection terminals of the first primary module 2Ba (to be specific, the antenna connection terminals 101a and 102a, the RF input terminal 111, the RF output terminal 121, and the diversity connection terminals 131a and 132a) are implemented by bump electrodes, planar electrodes or post electrodes, lands connected to bonding wires, or the like provided on or in the first module substrate.

The first module substrate may be, but is not limited to, an LTCC substrate, an HTCC substrate, a component built-in substrate, a substrate including an RDL (for example, an LTCC substrate including an RDL), a printed circuit board, or the like, having a multilayer structure of a plurality of dielectric layers, for example.

The circuit configuration of the first primary module 2Ba is not limited to the example illustrated in FIG. 9. For example, the first primary module 2Ba does not necessarily have to include the low-noise amplifier 21, the switch 31a, the switch 31b, the filter 41a, the filter 41b, the filter 45a, the filter 45b, or the RF output terminal 121.

### 3.3 CIRCUIT CONFIGURATION OF SECOND PRIMARY MODULE 2Bb

Next, the circuit configuration of the second primary module 2Bb will be described.

As illustrated in FIG. 9, the second primary module 2Bb includes the power amplifier 12, the low-noise amplifier 22, the switch 32, the filter 42, a filter 46, the antenna switch 51Bb, the antenna connection terminals 101b and 102b, the RF input terminal 112, the RF output terminal 122, and diversity connection terminals 131b and 132b.

The antenna connection terminal 101b is connected to the antenna 5a outside the second primary module 2Bb and is connected to the antenna terminal 51Bbc of the antenna switch 51Bb inside the second primary module 2Bb. To be specific, the antenna connection terminal 101b is connected to the antenna 5a via the filter 61b and the coupler 71.

The antenna connection terminal 102b is connected to the antenna 5b outside the second primary module 2Bb and is connected to the antenna terminal 51Bbd of the antenna switch 51Bb inside the second primary module 2Bb. To be specific, the antenna connection terminal 102b is connected to the antenna 5b via the filter 62b and the coupler 71.

The diversity connection terminal 131b is connected to a primary connection terminal 141b of the second diversity module 3Bb outside the second primary module 2Bb and is connected to a diversity terminal 51Bbe of the antenna switch 51Bb inside the second primary module 2Bb.

The diversity connection terminal 132b is connected to a primary connection terminal 142b of the second diversity module 3Bb outside the second primary module 2Bb and is connected to a diversity terminal 51Bbf of the antenna switch 51Bb inside the second primary module 2Bb.

The filter 46 is connected, for example, between a power amplifier and/or a low-noise amplifier and an input/output terminal 51Bbb of the antenna switch 51Bb. The filter 46 has a pass band including at least part of band D (fourth band). Band D is a band for TDD, but is not limited thereto and may be a band for FDD.

The antenna switch 51Bb is an example of a second switch included in the first switch circuit and includes input/output terminals 51Bba and 51Bbb, the antenna terminals 51Bbc and 51Bbd, and the diversity terminals 51Bbe and 51Bbf. In the present embodiment, the antenna switch 51Bb of the second primary module 2Bb and the antenna switch 51Ba of the first primary module 2Ba constitute the first switch circuit.

The input/output terminal 51Bba is an example of a second input/output terminal and is connected to the power amplifier 12. To be specific, the input/output terminal 51Bba is connected to the output end of the power amplifier 12 via the filter 42 and the switch 32.

The input/output terminal 51Bbb is connected to the filter 46. The input/output terminal 51Bbb does not necessarily have to be provided.

The antenna terminal 51Bbc is an example of one of the two first antenna terminals and is connected to the antenna 5a. To be specific, the antenna terminal 51Bbc is connected to the antenna 5a via the antenna connection terminal 101b, the filter 61b, and the coupler 71.

The antenna terminal 51Bbd is an example of one of the two second antenna terminals and is connected to the antenna 5b. To be specific, the antenna terminal 51Bbd is connected to the antenna 5b via the antenna connection terminal 102b, the filter 62b, and the coupler 71.

The diversity terminal 51Bbe is an example of one of the two first terminals (first diversity terminals) and is connected to a primary terminal 52Bbe of the antenna switch 52Bb included in the second diversity module 3Bb. To be specific, the diversity terminal 51Bbe is connected to the primary terminal 52Bbe via the diversity connection terminal 131b and the primary connection terminal 141b.

The diversity terminal 51Bbf is an example of one of the two second terminals (second diversity terminals) and is connected to a primary terminal 52Bbf of the antenna switch 52Bb included in the second diversity module 3Bb. To be specific, the diversity terminal 51Bbf is connected to the primary terminal 52Bbf via the diversity connection terminal 132b and the primary connection terminal 142b.

The antenna switch 51Bb is a multi-connection switch circuit. The input/output terminals 51Bba and 51Bbb are each selectively connectable to at least the antenna terminals 51Bbc and 51Bbd and the diversity terminal 51Bbe. The input/output terminals 51Bba and 51Bbb may be selectively connectable to the diversity terminal 51Bbf. The diversity terminal 51Bbf is selectively connectable to the antenna terminals 51Bbc and 51Bbd. The diversity terminal 51Bbe may be selectively connectable to the antenna terminals 51Bbc and 51Bbd. Switching of the connection relationship in the antenna switch 51Bb is performed by a controller, the RFIC 4, or the like.

In the present embodiment, the second primary module 2Bb is implemented on or in a second module substrate. The second primary module 2Bb may be a single-packaged module. In this case, the module may include a plurality of substrates.

The second module substrate is a substrate on or in which circuit elements included in the second primary module 2Bb are implemented. To be specific, the power amplifier 12 and the antenna switch 51Bb are implemented on or in the second module substrate. In addition, the low-noise amplifier 22, the switch 32, and the filters 42 and 46 are implemented on or in the second module substrate. These circuit elements may be implemented on only one of two main surfaces of the second module substrate, or may be implemented on both the two main surfaces. The individual external connection terminals of the second primary module 2Bb (to be specific, the antenna connection terminals 101b and 102b, the RF input terminal 112, the RF output terminal 122, and the diversity connection terminals 131b and 132b) are implemented by bump electrodes, planar electrodes or post electrodes, lands connected to bonding wires, or the like provided on or in the second module substrate.

The second module substrate may be, but is not limited to, an LTCC substrate, an HTCC substrate, a component built-in substrate, a substrate including an RDL (for example, an LTCC substrate including an RDL), a printed circuit board, or the like, having a multilayer structure of a plurality of dielectric layers, for example.

The circuit configuration of the second primary module 2Bb is not limited to the example illustrated in FIG. 9. For example, the second primary module 2Bb does not necessarily have to include the low-noise amplifier 22, the switch 32, the filter 42, the filter 46, or the RF output terminal 122.

### 3.4 CIRCUIT CONFIGURATION OF FIRST DIVERSITY MODULE 3Ba

Next, the circuit configuration of the first diversity module 3Ba will be described.

As illustrated in FIG. 9, the first diversity module 3Ba includes the low-noise amplifier 24, the switch 34, the filter 44, a filter 48, the antenna switch 52Ba, the antenna connection terminals 103a and 104a, the RF output terminal 124, and the primary connection terminals 141a and 142a.

The antenna connection terminal 103a is connected to the antenna 5c outside the first diversity module 3Ba and is connected to the antenna terminal 52Bac of the antenna switch 52Ba inside the first diversity module 3Ba. To be specific, the antenna connection terminal 103a is connected to the antenna 5c via the filter 63a and the coupler 72.

The antenna connection terminal 104a is connected to the antenna 5d outside the first diversity module 3Ba and is connected to the antenna terminal 52Bad of the antenna switch 52Ba inside the first diversity module 3Ba. To be specific, the antenna connection terminal 104a is connected to the antenna 5d via the filter 64a and the coupler 72.

The primary connection terminal 141a is connected to the diversity connection terminal 131a of the first primary module 2Ba outside the first diversity module 3Ba and is connected to the primary terminal 52Bae of the antenna switch 52Ba inside the first diversity module 3Ba.

The primary connection terminal 142a is connected to the diversity connection terminal 132a of the first primary module 2Ba outside the first diversity module 3Ba and is connected to the primary terminal 52Baf of the antenna switch 52Ba inside the first diversity module 3Ba.

The filter 48 is connected, for example, between a power amplifier and/or a low-noise amplifier and an input/output terminal 52Baa of the antenna switch 52Ba. The filter 48 has a pass band including at least part of band C (third band). Band C is a band for FDD, but is not limited thereto and may be a band for TDD.

The antenna switch 52Ba is an example of a fourth switch included in a second switch circuit and includes input/output terminals 52Baa and 52Bab, the antenna terminals 52Bac and 52Bad, and the primary terminals 52Bae and 52Baf. In the present embodiment, the second switch circuit includes at least two third antenna terminals, at least two fourth antenna terminals, at least two third terminals (first primary terminals), and at least two fourth terminals (second primary terminals).

The input/output terminal 52Baa is connected to the filter 48. The input/output terminal 52Baa does not necessarily have to be provided.

The input/output terminal 52Bab is an example of a fourth input/output terminal and is connected to the low-noise amplifier 24. To be specific, the input/output terminal 52Bab is connected to the input end of the low-noise amplifier 24 via the filter 44 and the switch 34.

The antenna terminal 52Bac is an example of one of the two third antenna terminals and is connected to the antenna 5c. To be specific, the antenna terminal 52Bac is connected to the antenna 5c via the antenna connection terminal 103a, the filter 63a, and the coupler 72.

The antenna terminal 52Bad is an example of one of the two fourth antenna terminals and is connected to the antenna 5d. To be specific, the antenna terminal 52Bad is connected to the antenna 5d via the antenna connection terminal 104a, the filter 64a, and the coupler 72.

The primary terminal 52Bae is an example of one of the two third terminals (first primary terminals) and is connected to the diversity terminal 51Bae of the antenna switch 51Ba included in the first primary module 2Ba. To be specific, the primary terminal 52Bae is connected to the diversity terminal 51Bae via the primary connection terminal 141a and the diversity connection terminal 131a.

The primary terminal 52Baf is an example of one of the two fourth terminals (second primary terminals) and is connected to the diversity terminal 51Baf of the antenna switch 51Ba included in the first primary module 2Ba. To be specific, the primary terminal 52Baf is connected to the diversity terminal 51Baf via the primary connection terminal 142a and the diversity connection terminal 132a.

The antenna switch 52Ba is a multi-connection switch circuit. The input/output terminals 52Baa and 52Bab are each selectively connectable to at least the antenna terminals 52Bac and 52Bad and the primary terminal 52Baf. The input/output terminals 52Baa and 52Bab may be selectively connectable to the primary terminal 52Bae. The primary terminal 52Bae is selectively connectable to the antenna terminals 52Bac and 52Bad. The primary terminal 52Baf may be selectively connectable to the antenna terminals 52Bac and 52Bad. Switching of the connection relationship in the antenna switch 52Ba is performed by a controller, the RFIC 4, or the like.

In the present embodiment, the first diversity module 3Ba is implemented on or in a fourth module substrate. The first diversity module 3Ba may be a single-packaged module. In this case, the module may include a plurality of substrates.

The fourth module substrate is a substrate on or in which circuit elements included in the first diversity module 3Ba are implemented. To be specific, the low-noise amplifier 24 and the antenna switch 52Ba are implemented on or in the fourth module substrate. In addition, the switch 34 and the filters 44 and 48 are implemented on or in the fourth module substrate. These circuit elements may be implemented on only one of two main surfaces of the fourth module substrate, or may be implemented on both the two main surfaces. The individual external connection terminals of the first diversity module 3Ba (to be specific, the antenna connection terminals 103a and 104a, the RF output terminal 124, and the primary connection terminals 141a and 142a) are implemented by bump electrodes, planar electrodes or post electrodes, lands connected to bonding wires, or the like provided on or in the fourth module substrate.

The fourth module substrate may be, but is not limited to, an LTCC substrate, an HTCC substrate, a component built-in substrate, a substrate including an RDL (for example, an LTCC substrate including an RDL), a printed circuit board, or the like, having a multilayer structure of a plurality of dielectric layers, for example.

The circuit configuration of the first diversity module 3Ba is not limited to the example illustrated in FIG. 9. For example, the first diversity module 3Ba does not necessarily have to include the switch 34, the filter 44, or the filter 48. For example, the first diversity module 3Ba does not necessarily have to include the low-noise amplifier 24 or the RF output terminal 124. In this case, the antenna switch 52Ba does not necessarily have to include the input/output terminal 52Bab. The first diversity module 3Ba may include one or more power amplifiers and one or more RF input terminals connected to one or more input ends of the one or more power amplifiers.

### 3.5 CIRCUIT CONFIGURATION OF SECOND DIVERSITY MODULE 3Bb

Next, the circuit configuration of the second diversity module 3Bb will be described.

As illustrated in FIG. 9, the second diversity module 3Bb includes the power amplifier 13, the low-noise amplifier 23, the switch 33, the filter 43, a filter 47, the antenna switch 52Bb, the antenna connection terminals 103b and 104b, the RF input terminal 113, the RF output terminal 123, and the primary connection terminals 141b and 142b.

The antenna connection terminal 103b is connected to the antenna 5c outside the second diversity module 3Bb and is connected to the antenna terminal 52Bbc of the antenna switch 52Bb inside the second diversity module 3Bb. To be specific, the antenna connection terminal 103b is connected to the antenna 5c via the filter 63b and the coupler 72.

The antenna connection terminal 104b is connected to the antenna 5d outside the second diversity module 3Bb and is connected to the antenna terminal 52Bbd of the antenna switch 52Bb inside the second diversity module 3Bb. To be specific, the antenna connection terminal 104b is connected to the antenna 5d via the filter 64b and the coupler 72.

The primary connection terminal 141b is connected to the diversity connection terminal 131b of the second primary module 2Bb outside the second diversity module 3Bb and is connected to the primary terminal 52Bbe of the antenna switch 52Bb inside the second diversity module 3Bb.

The primary connection terminal 142b is connected to the diversity connection terminal 132b of the second primary module 2Bb outside the second diversity module 3Bb and is connected to the primary terminal 52Bbf of the antenna switch 52Bb inside the second diversity module 3Bb.

The filter 47 is connected, for example, between a power amplifier and/or a low-noise amplifier and an input/output terminal 52Bba of the antenna switch 52Bb. The filter 47 has a pass band including at least part of band D (fourth band). Band D is a band for TDD, but is not limited thereto and may be a band for FDD.

The antenna switch 52Bb is an example of a third switch included in the second switch circuit and includes input/output terminals 52Bba and 52Bbb, the antenna terminals 52Bbc and 52Bbd, and the primary terminals 52Bbe and 52Bbf. In the present embodiment, the antenna switch 52Bb of the second diversity module 3Bb and the antenna switch 52Ba of the first diversity module 3Ba constitute the second switch circuit.

The input/output terminal 52Bba is connected to the filter 47. The input/output terminal 52Bba does not necessarily have to be provided.

The input/output terminal 52Bbb is an example of a third input/output terminal and is connected to the power amplifier 13. To be specific, the input/output terminal 52Bbb is connected to the output end of the power amplifier 13 via the filter 43 and the switch 33.

The antenna terminal 52Bbc is an example of one of the two third antenna terminals and is connected to the antenna 5c. To be specific, the antenna terminal 52Bbc is connected to the antenna 5c via the antenna connection terminal 103b, the filter 63b, and the coupler 72.

The antenna terminal 52Bbd is an example of one of the two fourth antenna terminals and is connected to the antenna 5d. To be specific, the antenna terminal 52Bbd is connected to the antenna 5d via the antenna connection terminal 104b, the filter 64b, and the coupler 72.

The primary terminal 52Bbe is an example of one of the two third terminals (first primary terminals) and is connected to the diversity terminal 51Bbe of the antenna switch 51Bb included in the second primary module 2Bb. To be specific, the primary terminal 52Bbe is connected to the diversity terminal 51Bbe via the primary connection terminal 141b and the diversity connection terminal 131b.

The primary terminal 52Bbf is an example of one of the two fourth terminals (second primary terminals) and is connected to the diversity terminal 51Bbf of the antenna switch 51Bb included in the second primary module 2Bb. To be specific, the primary terminal 52Bbf is connected to the diversity terminal 51Bbf via the primary connection terminal 142b and the diversity connection terminal 132b.

The antenna switch 52Bb is a multi-connection switch circuit. The input/output terminals 52Bba and 52Bbb are each selectively connectable to at least the antenna terminals 52Bbc and 52Bbd and the primary terminal 52Bbf. The input/output terminals 52Bba and 52Bbb may be selectively connectable to the primary terminal 52Bbe. The primary terminal 52Bbe is selectively connectable to the antenna terminals 52Bbc and 52Bbd. The primary terminal 52Bbf may be selectively connectable to the antenna terminals 52Bbc and 52Bbd. Switching of the connection relationship in the antenna switch 52Bb is performed by a controller, the RFIC 4, or the like.

In the present embodiment, the second diversity module 3Bb is implemented on or in a third module substrate. The second diversity module 3Bb may be a single-packaged module. In this case, the module may include a plurality of substrates.

The third module substrate is a substrate on or in which circuit elements included in the second diversity module 3Bb are implemented. To be specific, the power amplifier 13 and the antenna switch 52Bb are implemented on or in the third module substrate. In addition, the low-noise amplifier 23, the switch 33, and the filters 43 and 47 are implemented on or in the third module substrate. These circuit elements may be implemented on only one of two main surfaces of the third module substrate, or may be implemented on both the two main surfaces. The individual external connection terminals of the second diversity module 3Bb (to be specific, the antenna connection terminals 103b and 104b, the RF input terminal 113, the RF output terminal 123, and the primary connection terminals 141b and 142b) are implemented by bump electrodes, planar electrodes or post electrodes, lands connected to bonding wires, or the like provided on or in the third module substrate.

The third module substrate may be, but is not limited to, an LTCC substrate, an HTCC substrate, a component built-in substrate, a substrate including an RDL (for example, an LTCC substrate including an RDL), a printed circuit board, or the like, having a multilayer structure of a plurality of dielectric layers, for example.

The circuit configuration of the second diversity module 3Bb is not limited to the example illustrated in FIG. 9. For example, the second diversity module 3Bb does not necessarily have to include the low-noise amplifier 23, the switch 33, the filter 43, the filter 47, or the RF output terminal 123.

### 3.6 OPERATION EXAMPLES

Hereinafter, specific operation examples of the above-described RF circuit 1B will be described.

The RF circuit 1B includes two antenna terminals connected to the antenna 5a, two antenna terminals connected to the antenna 5b, two antenna terminals connected to the antenna 5c, and two antenna terminals connected to the antenna 5d. In this case, the four input/output terminals 51Baa, 51Bba, 52Bbb, and 52Bab are each connectable to at least one of the two antenna terminals connected to the same antenna. To be specific, the four input/output terminals 51Baa, 51Bba, 52Bbb, and 52Bab are each selectively connectable to at least one of the antenna terminals 51Bac and 51Bbc, at least one of the antenna terminals 51Bad and 51Bbd, at least one of the antenna terminals 52Bac and 52Bbc, and at least one of the antenna terminals 52Bad and 52Bbd. In addition, for example, the other input/output terminals 51Bab, 51Bbb, 52Bba, and 52Baa are selectively connectable to at least one of the antenna terminals 51Bac and 51Bbc, at least one of the antenna terminals 51Bad and 51Bbd, at least one of the antenna terminals 52Bac and 52Bbc, and at least one of the antenna terminals 52Bad and 52Bbd.

The combination of connections between the input/output terminals and the antenna terminals is controlled by a controller or the RFIC 4. For example, connections can be switched in accordance with the communication statuses, antenna characteristics (sensitivity and radiation quality), or the like of the antennas 5a, 5b, 5c, and 5d. In the RF circuit 1B, antennas can be selected highly freely. To be specific, any of the antennas 5a, 5b, 5c, and 5d is selectable in the case of receiving one reception signal. For example, an antenna can be selected by placing priority on reception of a reception signal, and three transmission signals can be transmitted by using the three other antennas. Alternatively, priority can be placed on transmission of at least one transmission signal among three transmission signals. In this way, appropriate antennas can be selected in accordance with a situation, and thus the quality of a reception signal and/or a transmission signal can be increased.

Hereinafter, a description will be given of an example in which band A is band n28A for 5G-NR and band B is band n41 for 5G-NR (the combination in the top row in Table 1), but the combination of band A and band B is not limited thereto. The combination of band A and band B may be any combination shown in Table 1 or another combination. An example is illustrated in which band C and band D are band n28B and band n40 for 5G-NR, respectively, but the combination of band C and band D is not particularly limited.

### 3.6.1 First Operation Example

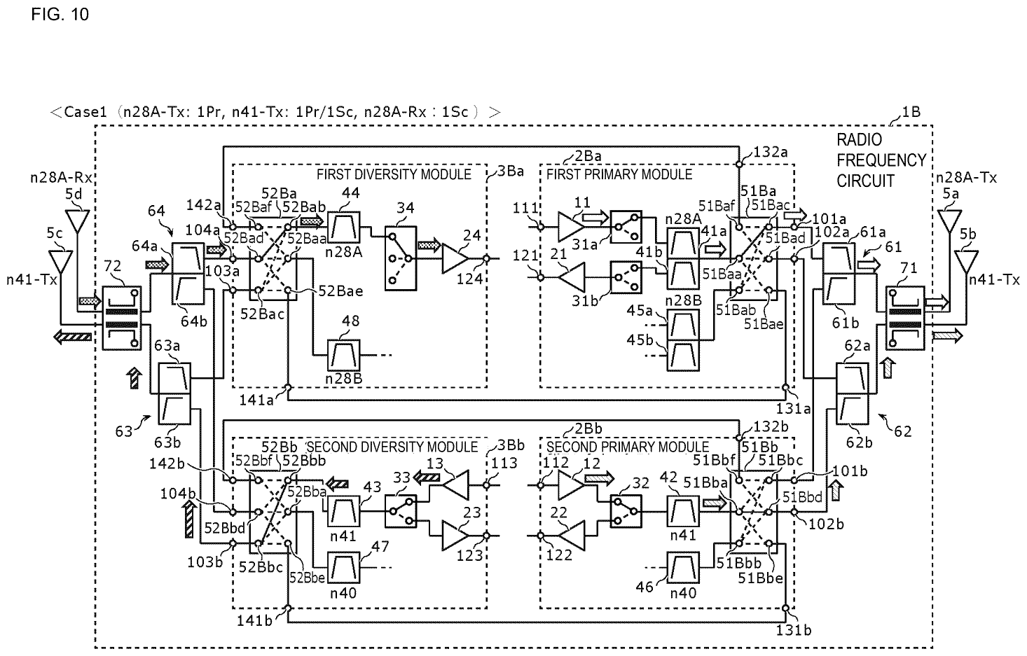

First, a first operation example will be described with reference to FIG. 10. FIG. 10 is a diagram illustrating a first operation example (case 1) of the RF circuit 1B according to the present embodiment.

In the present operation example, the RF circuit 1B outputs a transmission signal of band n28A to one of the antennas 5a and 5b connected to the first primary module 2Ba and the second primary module 2Bb, outputs one of two transmission signals of band n41 to the other of the antennas 5a and 5b, outputs the other of the two transmission signals of band n41 to one of the antennas 5c and 5d connected to the first diversity module 3Ba and the second diversity module 3Bb, and receives a reception signal of band n28A from the other of the antennas 5c and 5d.

To be specific, the antenna terminal 51Bac of the antenna switch 51Ba is connected to the input/output terminal 51Baa, and the antenna terminal 51Bbd of the antenna switch 51Bb is connected to the input/output terminal 51Bba, as illustrated in FIG. 10. In this case, the antenna terminal 52Bbc of the antenna switch 52Bb is connected to the input/output terminal 52Bbb, and the antenna terminal 52Bad of the antenna switch 52Ba is connected to the input/output terminal 52Bab.

Accordingly, the transmission signal of band n28A amplified by the power amplifier 11 is output to the antenna 5a via the switch 31a, the filter 41a, the input/output terminal 51Baa, the antenna terminal 51Bac, the antenna connection terminal 101a, the filter 61a, and the coupler 71, and is radiated from the antenna 5a. The transmission signal of band n41 amplified by the power amplifier 12 is output to the antenna 5b via the switch 32, the filter 42, the input/output terminal 51Bba, the antenna terminal 51Bbd, the antenna connection terminal 102b, the filter 62b, and the coupler 71, and is radiated from the antenna 5b. The transmission signal of band n41 amplified by the power amplifier 13 is output to the antenna 5c via the switch 33, the filter 43, the input/output terminal 52Bbb, the antenna terminal 52Bbc, the antenna connection terminal 103b, the filter 63b, and the coupler 72, and is radiated from the antenna 5c. The reception signal received by the antenna 5d is input to the low-noise amplifier 24 via the coupler 72, the filter 64a, the antenna connection terminal 104a, the antenna terminal 52Bad, the input/output terminal 52Bab, the filter 44, and the switch 34.

Alternatively, the antenna terminal 52Bbd may be connected to the input/output terminal 52Bbb, and the antenna terminal 52Bac may be connected to the input/output terminal 52Bab. In this case, the transmission signal of band n41 amplified by the power amplifier 13 is radiated from the antenna 5d, and the reception signal of band n28A received by the antenna 5c is input to the low-noise amplifier 24. Alternatively, the antenna terminal 51Bbc may be connected to the input/output terminal 51Bba, and the antenna terminal 51Bad may be connected to the input/output terminal 51Baa. In this case, the transmission signal of band n41 amplified by the power amplifier 12 is radiated from the antenna 5a, and the transmission signal of band n28A amplified by the power amplifier 11 is radiated from the antenna 5b.

### 3.6.2 Second Operation Example

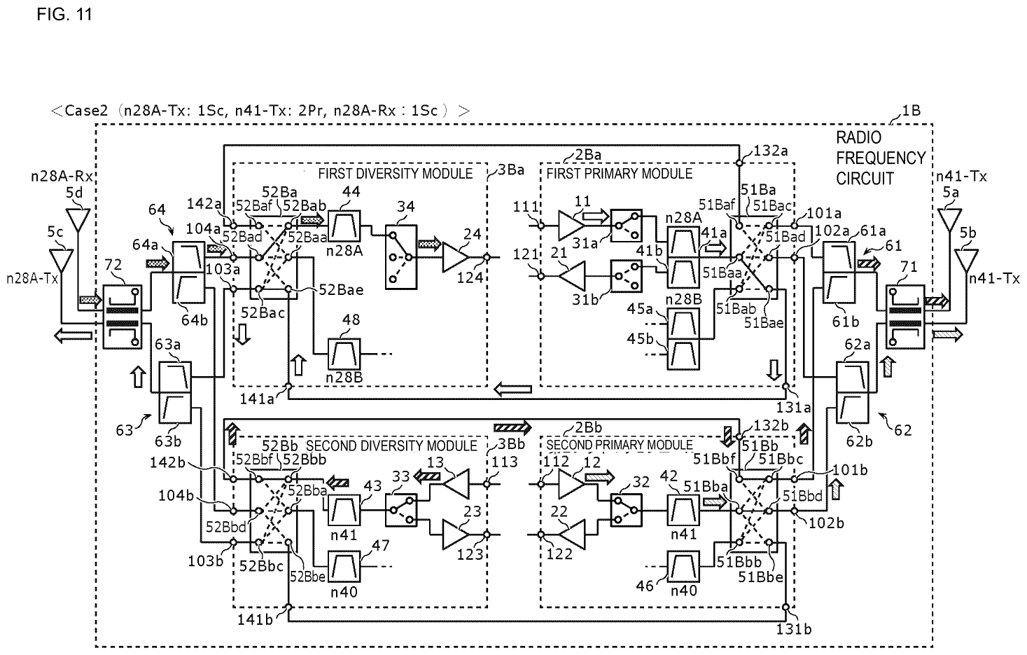

Next, a second operation example will be described with reference to FIG. 11. FIG. 11 is a diagram illustrating a second operation example (case 2) of the RF circuit 1B according to the present embodiment.

In the present operation example, the RF circuit 1B outputs a transmission signal of band n28A to one of the antennas 5c and 5d connected to the first diversity module 3Ba and the second diversity module 3Bb, respectively outputs two transmission signals of band n41 to the antennas 5a and 5b connected to the first primary module 2Ba and the second primary module 2Bb, and receives a reception signal of band n28A from the other of the antennas 5c and 5d.

To be specific, the antenna terminal 51Bbc of the antenna switch 51Bb is connected to the diversity terminal 51Bbf, the antenna terminal 51Bbd is connected to the input/output terminal 51Bba, and the diversity terminal 51Bae of the antenna switch 51Ba is connected to the input/output terminal 51Baa, as illustrated in FIG. 11. In this case, the antenna terminal 52Bac of the antenna switch 52Ba is connected to the primary terminal 52Bae, the antenna terminal 52Bad is connected to the input/output terminal 52Bab, and the primary terminal 52Bbf of the antenna switch 52Bb is connected to the input/output terminal 52Bbb.

Accordingly, the transmission signal of band n28A amplified by the power amplifier 11 is output to the antenna 5c via the switch 31a, the filter 41a, the input/output terminal 51Baa, the diversity terminal 51Bae, the diversity connection terminal 131a, the primary connection terminal 141a, the primary terminal 52Bae, the antenna terminal 52Bac, the antenna connection terminal 103a, the filter 63a, and the coupler 72, and is radiated from the antenna 5c.

The transmission signal of band n41 amplified by the power amplifier 12 is output to the antenna 5b via the switch 32, the filter 42, the input/output terminal 51Bba, the antenna terminal 51Bbd, the antenna connection terminal 102b, the filter 62b, and the coupler 71, and is radiated from the antenna 5b. The transmission signal of band n41 amplified by the power amplifier 13 is output to the antenna 5a via the switch 33, the filter 43, the input/output terminal 52Bbb, the primary terminal 52Bbf, the primary connection terminal 142b, the diversity connection terminal 132b, the diversity terminal 51Bbf, the antenna terminal 51Bbc, the antenna connection terminal 101b, the filter 61b, and the coupler 71, and is radiated from the antenna 5a. The reception signal received by the antenna 5d is input to the low-noise amplifier 24 via the coupler 72, the filter 64a, the antenna connection terminal 104a, the antenna terminal 52Bad, the input/output terminal 52Bab, the filter 44, and the switch 34.

Alternatively, the antenna terminal 52Bad may be connected to the primary terminal 52Bae, and the antenna terminal 52Bac may be connected to the input/output terminal 52Bab. In this case, the transmission signal of band n28A amplified by the power amplifier 11 is radiated from the antenna 5d, and the reception signal of band n28A received by the antenna 5c is input to the low-noise amplifier 24. Alternatively, the antenna terminal 51Bbc may be connected to the input/output terminal 51Bba, and the antenna terminal 51Bbd may be connected to the diversity terminal 51Bbf. In this case, the transmission signal of band n41 amplified by the power amplifier 12 is radiated from the antenna 5a, and the transmission signal of band n41 amplified by the power amplifier 13 is radiated from the antenna 5b.

### 3.6.3 Third Operation Example

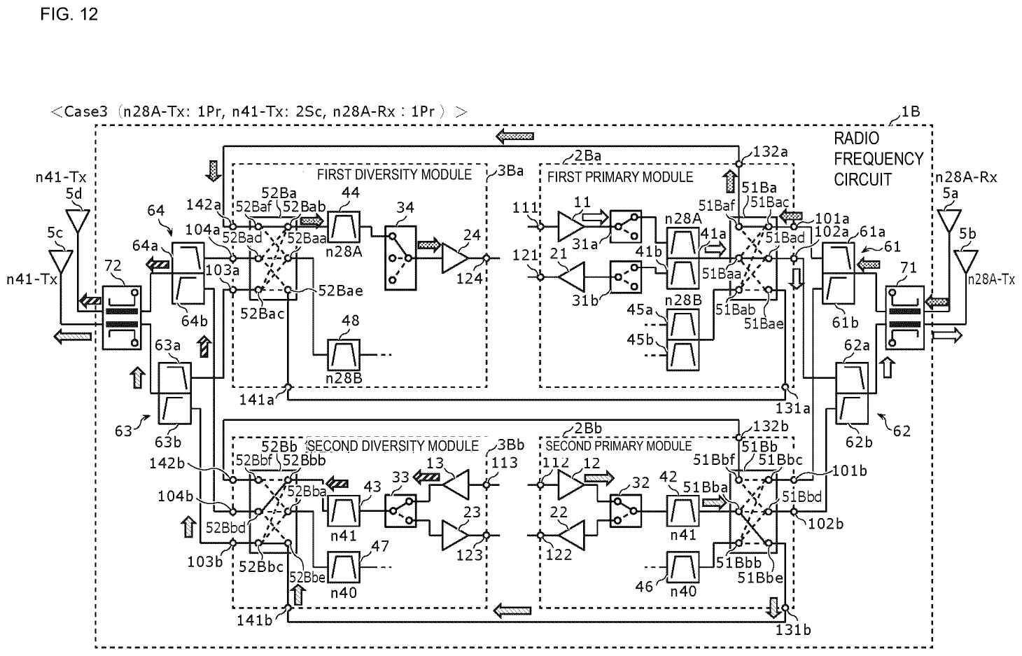

Next, a third operation example will be described with reference to FIG. 12. FIG. 12 is a diagram illustrating a third operation example (case 3) of the RF circuit 1B according to the present embodiment.

In the present operation example, the RF circuit 1B outputs a transmission signal of band n28A to one of the antennas 5a and 5b connected to the first primary module 2Ba and the second primary module 2Bb, respectively outputs two transmission signals of band n41 to the antennas 5c and 5d connected to the first diversity module 3Ba and the second diversity module 3Bb, and receives a reception signal of band n28A from the other of the antennas 5a and 5b.

To be specific, the antenna terminal 51Bad of the antenna switch 51Ba is connected to the input/output terminal 51Baa, the antenna terminal 51Bac is connected to the diversity terminal 51Baf, and the diversity terminal 51Bbe of the antenna switch 51Bb is connected to the input/output terminal 51Bba, as illustrated in FIG. 12. In this case, the antenna terminal 52Bbc of the antenna switch 52Bb is connected to the primary terminal 52Bbe, the antenna terminal 52Bbd is connected to the input/output terminal 52Bbb, and the primary terminal 52Baf of the antenna switch 52Ba is connected to the input/output terminal 52Bab.

Accordingly, the transmission signal of band n28A amplified by the power amplifier 11 is output to the antenna 5b via the switch 31a, the filter 41a, the input/output terminal 51Baa, the antenna terminal 51Bad, the antenna connection terminal 102a, the filter 62a, and the coupler 71, and is radiated from the antenna 5b. The transmission signal of band n41 amplified by the power amplifier 12 is output to the antenna 5c via the switch 32, the filter 42, the input/output terminal 51Bba, the diversity terminal 51Bbe, the diversity connection terminal 131b, the primary connection terminal 141b, the primary terminal 52Bbe, the antenna terminal 52Bbc, the antenna connection terminal 103b, the filter 63b, and the coupler 72, and is radiated from the antenna 5c. The transmission signal of band n41 amplified by the power amplifier 13 is output to the antenna 5d via the switch 33, the filter 43, the input/output terminal 52Bbb, the antenna terminal 52Bbd, the antenna connection terminal 104b, the filter 64b, and the coupler 72, and is radiated from the antenna 5d. The reception signal received by the antenna 5a is input to the low-noise amplifier 24 via the coupler 71, the filter 61a, the antenna connection terminal 101a, the antenna terminal 51Bac, the diversity terminal 51Baf, the diversity connection terminal 132a, the primary connection terminal 142a, the primary terminal 52Baf, the input/output terminal 52Bab, the filter 44, and the switch 34.

Alternatively, the antenna terminal 51Bac may be connected to the input/output terminal 51Baa, and the antenna terminal 51Bad may be connected to the diversity terminal 51Baf. In this case, the transmission signal of band n28A amplified by the power amplifier 11 is radiated from the antenna 5a, and the reception signal of band n28A received by the antenna 5b is input to the low-noise amplifier 24. Alternatively, the antenna terminal 52Bbc may be connected to the input/output terminal 52Bbb, and the antenna terminal 52Bbd may be connected to the primary terminal 52Bbe. In this case, the transmission signal of band n41 amplified by the power amplifier 12 is radiated from the antenna 5d, and the transmission signal of band n41 amplified by the power amplifier 13 is radiated from the antenna 5c.

### 3.6.4 Fourth Operation Example

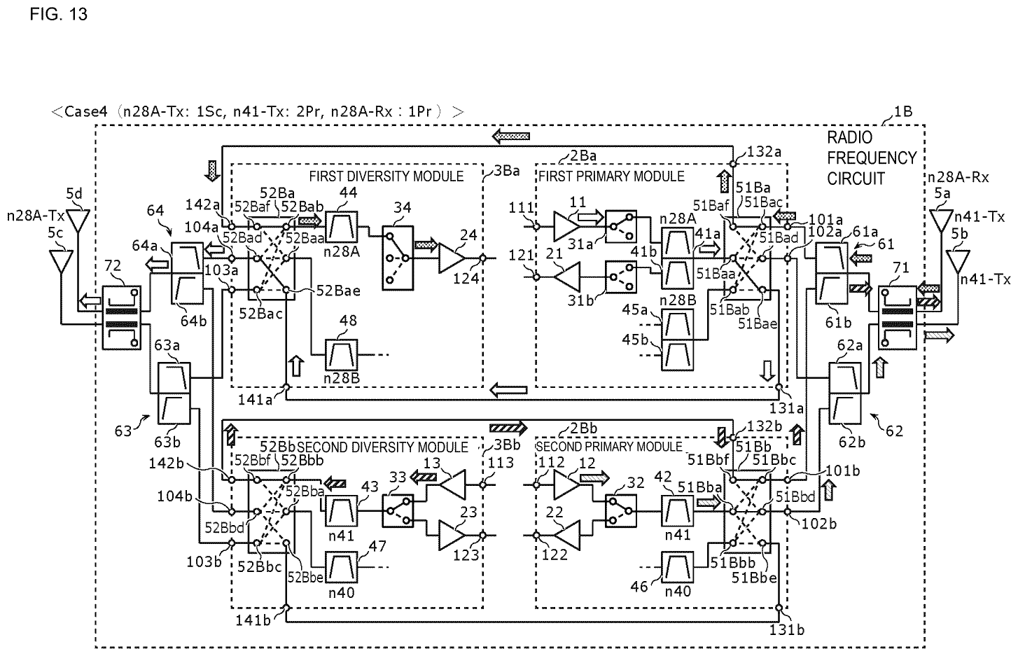

Next, a fourth operation example will be described with reference to FIG. 13. FIG. 13 is a diagram illustrating a fourth operation example (case 4) of the RF circuit 1B according to the present embodiment.

In the present operation example, the RF circuit 1B outputs a transmission signal of band n28A to one of the antennas 5c and 5d connected to the first diversity module 3Ba and the second diversity module 3Bb, respectively outputs two transmission signals of band n41 to the antennas 5a and 5b connected to the first primary module 2Ba and the second primary module 2Bb, and receives a reception signal of band n28A from either of the antennas 5a and 5b.

To be specific, the antenna terminal 51Bbc of the antenna switch 51Bb is connected to the diversity terminal 51Bbf, the antenna terminal 51Bbd is connected to the input/output terminal 51Bba, the diversity terminal 51Bae of the antenna switch 51Ba is connected to the input/output terminal 51Baa, and the antenna terminal 51Bac is connected to the diversity terminal 51Baf, as illustrated in FIG. 13. In this case, the antenna terminal 52Bad of the antenna switch 52Ba is connected to the primary terminal 52Bae, the primary terminal 52Baf is connected to the input/output terminal 52Bab, and the primary terminal 52Bbf of the antenna switch 52Bb is connected to the input/output terminal 52Bbb.

Accordingly, the transmission signal of band n28A amplified by the power amplifier 11 is output to the antenna 5d via the switch 31a, the filter 41a, the input/output terminal 51Baa, the diversity terminal 51Bae, the diversity connection terminal 131a, the primary connection terminal 141a, the primary terminal 52Bae, the antenna terminal 52Bad, the antenna connection terminal 104a, the filter 64a, and the coupler 72, and is radiated from the antenna 5d. The transmission signal of band n41 amplified by the power amplifier 12 is output to the antenna 5b via the switch 32, the filter 42, the input/output terminal 51Bba, the antenna terminal 51Bbd, the antenna connection terminal 102b, the filter 62b, and the coupler 71, and is radiated from the antenna 5b. The transmission signal of band n41 amplified by the power amplifier 13 is output to the antenna 5a via the switch 33, the filter 43, the input/output terminal 52Bbb, the primary terminal 52Bbf, the primary connection terminal 142b, the diversity connection terminal 132b, the diversity terminal 51Bbf, the antenna terminal 51Bbc, the antenna connection terminal 101b, the filter 61b, and the coupler 71, and is radiated from the antenna 5a. The reception signal received by the antenna 5a is input to the low-noise amplifier 24 via the coupler 71, the filter 61a, the antenna connection terminal 101a, the antenna terminal 51Bac, the diversity terminal 51Baf, the diversity connection terminal 132a, the primary connection terminal 142a, the primary terminal 52Baf, the input/output terminal 52Bab, the filter 44, and the switch 34. In this way, the antenna 5a may be used for both transmission of a signal of band n41 and reception of a signal of band n28A.

The input/output terminal 52Bab connected to the low-noise amplifier 24 may be connected to the antenna terminal 52Bad. In this case, the antenna 5d is used for transmission and reception of a signal of band n28A. Alternatively, the diversity terminal 51Baf of the antenna switch 51Ba may be connected to the antenna terminal 51Bad. In this case, the antenna 5b is used for both transmission of a signal of band n41 and reception of a signal of band n28A. The antenna used for both transmission and reception may be any of the antennas 5a, 5b, 5c, and 5d.

### 3.7 ADVANTAGEOUS EFFECTS AND THE LIKE

As described above, in the RF circuit 1B according to the present embodiment, the first switch circuit includes at least two first antenna terminals, at least two second antenna terminals, at least two first terminals (first diversity terminals), and at least two second terminals (second diversity terminals). The first switch circuit includes the antenna switch 51Ba including the input/output terminal 51Baa, the antenna terminals 51Bac and 51Bad, and the diversity terminals 51Bae and 51Baf; and the antenna switch 51Bb including the input/output terminal 51Bba, the antenna terminals 51Bbc and 51Bbd, and the diversity terminals 51Bbe and 51Bbf. The second switch circuit includes at least two third antenna terminals, at least two fourth antenna terminals, at least two third terminals (first primary terminals), and at least two fourth terminals (second primary terminals). The second switch circuit includes the antenna switch 52Bb including the input/output terminal 52Bbb, the antenna terminals 52Bbc and 52Bbd, and the primary terminals 52Bbe and 52Bbf; and the antenna switch 52Ba including the antenna terminals 52Bac and 52Bad and the primary terminals 52Bae and 52Baf.

Accordingly, the RF circuit 1B that is compact and that reduces deterioration of signal quality during simultaneous transfer can be implemented. For example, the four antennas usable for transmitting RF signals are provided, and thus the antennas can be used by switching therebetween in accordance with communication statuses or the like. Appropriate antennas can be used in accordance with a situation, and thus deterioration of signal quality can be reduced. Because the first switch circuit includes the antenna switches 51Ba and 51Bb and the second switch circuit includes the antenna switches 52Bb and 52Ba, the first transfer circuit and the second transfer circuit can each be disposed in a distributed manner on or in two module substrates.

For example, the antenna switch 51Ba and the power amplifier 11 are implemented on or in a first substrate, the antenna switch 51Bb and the power amplifier 12 are implemented on or in a second substrate, the antenna switch 52Bb and the power amplifier 13 are implemented on or in a third substrate, and the antenna switch 52Ba and the low-noise amplifier 24 are implemented on or in a fourth substrate.

Accordingly, the three power amplifiers 11, 12, and 13 and the low-noise amplifier 24 are disposed in a distributed manner in four modules, and thus the heat generated from signal amplification can be dispersed. As compared to a case where an RF circuit is constituted by a single module, heat concentration reduces and heat dissipation efficiency increases, and thus a decreased size of the individual modules is realized.

For example, the second transfer circuit further includes the low-noise amplifier 24. The antenna switch 52Ba further includes the input/output terminal 52Bab connected to the low-noise amplifier 24. The input/output terminal 52Bab is connectable to the antenna terminals 51Bac, 51Bad, 52Bac, and 52Bad.

Accordingly, the RF circuit 1B that is compact and that reduces deterioration of signal quality during simultaneous transmission and reception can be implemented. For example, an optimal antenna can be used for reception with priority placed on reception of a signal, and thus a transmission signal can be transmitted while the quality of a reception signal is increased.

For example, as in the first operation example, when the first switch circuit is in a state in which one of the antenna terminals 51Bac and 51Bad included in the antenna switch 51Ba is connected to the input/output terminal 51Baa, and one of the antenna terminals 51Bbc and 51Bbd included in the antenna switch 51Bb is connected to the input/output terminal 51Bba, the second switch circuit is in a state in which one of the antenna terminals 52Bbc and 52Bbd included in the antenna switch 52Bb is connected to the input/output terminal 52Bbb, and one of the antenna terminals 52Bac and 52Bad included in the antenna switch 52Ba is connected to the input/output terminal 52Bab.

Accordingly, the transmission signals amplified by the respective power amplifiers 11 and 12 of the first primary module 2Ba and the second primary module 2Bb are radiated from the antennas 5a and 5b connected to the first primary module 2Ba and the second primary module 2Bb. For example, disposing the first primary module 2Ba and the second primary module 2Bb close to the antennas 5a and 5b reduces the lengths of wiring lines through which the transmission signals are transferred, and thus the loss and deterioration of the transmission signals can be reduced. The transmission signal amplified by the power amplifier 13 of the second diversity module 3Bb is radiated from the antenna 5c or 5d connected to the second diversity module 3Bb. The reception signal received by the antenna 5c or 5d connected to the first diversity module 3Ba is amplified by the low-noise amplifier 24 of the first diversity module 3Ba. For example, disposing the first diversity module 3Ba and the second diversity module 3Bb close to the antennas 5c and 5d reduces the lengths of wiring lines through which the transmission signal and the reception signal are transferred, and thus the loss and deterioration of the transmission signal and the reception signal can be reduced.

For example, as in the second operation example, when the first switch circuit is in a state in which one of the antenna terminals 51Bbc and 51Bbd included in the antenna switch 51Bb is connected to the diversity terminal 51Bbf included in the antenna switch 51Bb, the other of the antenna terminals 51Bbc and 51Bbd included in the antenna switch 51Bb is connected to the input/output terminal 51Bba, and the diversity terminal 51Bae included in the antenna switch 51Ba is connected to the input/output terminal 51Baa, the second switch circuit is in a state in which one of the antenna terminals 52Bac and 52Bad included in the antenna switch 52Ba is connected to the primary terminal 52Bae included in the antenna switch 52Ba, the other of the antenna terminals 52Bac and 52Bad included in the antenna switch 52Ba is connected to the input/output terminal 52Bab, and the primary terminal 52Bbf included in the antenna switch 52Bb is connected to the input/output terminal 52Bbb.

Accordingly, the reception signal to be input to the low-noise amplifier 24 of the first diversity module 3Ba is received by the antenna 5c or 5d connected to the first diversity module 3Ba. For example, when the communication status of the antenna 5c or 5d is favorable and the quality of a reception signal has higher priority than the quality of a transmission signal, the priority can be fulfilled. When the antenna characteristics of the antennas 5a and 5b are more suitable for band n41 than those of the antennas 5c and 5d, the quality of the transmission signal of band n41 can be increased.

For example, as in the third operation example, when the first switch circuit is in a state in which one of the antenna terminals 51Bac and 51Bad included in the antenna switch 51Ba is connected to the input/output terminal 51Baa, the other of the antenna terminals 51Bac and 51Bad included in the antenna switch 51Ba is connected to the diversity terminal 51Baf included in the antenna switch 51Ba, and the diversity terminal 51Bbe included in the antenna switch 51Bb is connected to the input/output terminal 51Bba, the second switch circuit is in a state in which one of the antenna terminals 52Bbc and 52Bbd included in the antenna switch 52Bb is connected to the input/output terminal 52Bbb, the other of the antenna terminals 52Bbc and 52Bbd included in the antenna switch 52Bb is connected to the primary terminal 52Bbe included in the antenna switch 52Bb, and the primary terminal 52Baf included in the antenna switch 52Ba is connected to the input/output terminal 52Bab.

Accordingly, the reception signal to be input to the low-noise amplifier 24 of the first diversity module 3Ba is received by the antenna 5a or 5b connected to the first primary module 2Ba. For example, when the communication statuses of the antennas 5a and 5b are favorable and the quality of a reception signal has higher priority than the quality of a transmission signal, the priority can be fulfilled. When the antenna characteristics of the antennas 5c and 5d are more suitable for band n41 than those of the antennas 5a and 5b, the quality of the transmission signal of band n41 can be increased.

For example, the RF circuit 1B includes the diplexer 61 connected to the antenna terminal 51Bac included in the antenna switch 51Ba, the antenna terminal 51Bbc included in the antenna switch 51Bb, and the antenna 5a; the diplexer 62 connected to the antenna terminal 51Bad included in the antenna switch 51Ba, the antenna terminal 51Bbd included in the antenna switch 51Bb, and the antenna 5b; the diplexer 63 connected to the antenna terminal 52Bbc included in the antenna switch 52Bb, the antenna terminal 52Bac included in the antenna switch 52Ba, and the antenna 5c; and the diplexer 64 connected to the antenna terminal 52Bbd included in the antenna switch 52Bb, the antenna terminal 52Bad included in the antenna switch 52Ba, and the antenna 5d.

Accordingly, for example, a module that processes a low-band signal (the first primary module 2Ba and the first diversity module 3Ba) and a module that processes a high-band signal (the second primary module 2Bb and the second diversity module 3Bb) can be separated from each other. The isolation between a low-band signal and a high-band signal can be enhanced, and thus the quality of the individual signals can be increased.

### Fourth Embodiment

Next, a fourth embodiment will be described.

The fourth embodiment is different from the third embodiment mainly in that a triplexer is provided instead of one diplexer. The triplexer includes a filter having a pass band including a WLAN 2.4 GHz band. Hereinafter, the differences from the third embodiment will be mainly described, and the description of common features will be omitted or simplified.

### 4.1 CIRCUIT CONFIGURATION OF RF CIRCUIT 1C

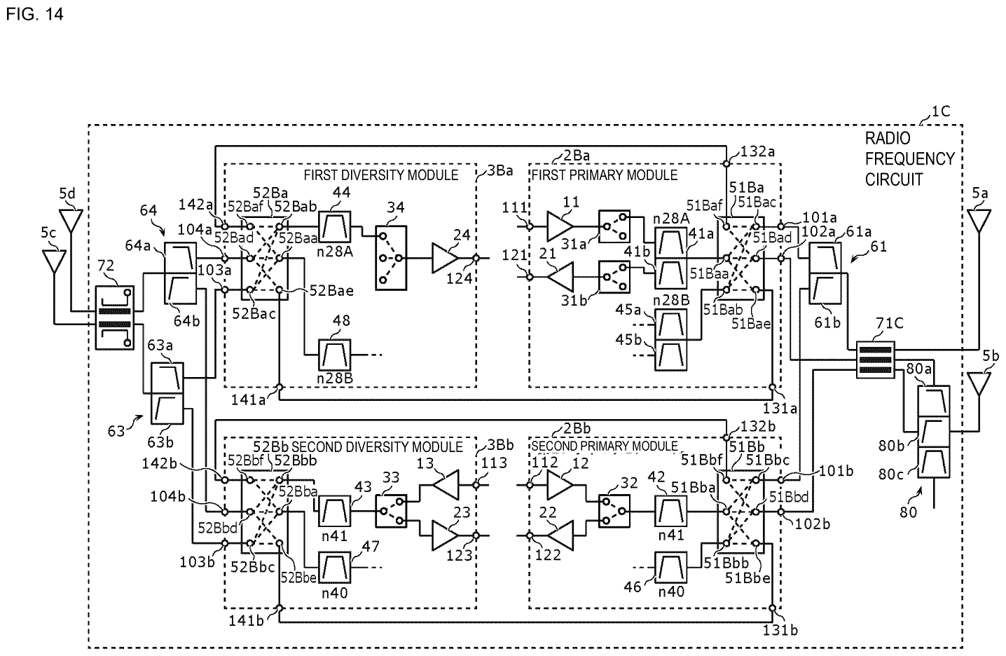

The circuit configuration of an RF circuit 1C according to the present embodiment will be described with reference to FIG. 14. FIG. 14 is a circuit configuration diagram of the RF circuit 1C according to the present embodiment.

FIG. 14 illustrates an exemplary circuit configuration. The RF circuit 1C can be implemented by using any of a wide variety of circuit implementations and circuit techniques. Thus, the description of the RF circuit 1C provided below is not to be construed in a limiting manner.

The communication device according to the present embodiment is similar to the communication device 6 according to the first embodiment except that the RF circuit 1C is included instead of the RF circuit 1, and thus the illustration and description thereof is omitted.

As illustrated in FIG. 14, the RF circuit 1C is different from the configuration of the RF circuit 1B illustrated in FIG. 9 in that a triplexer 80 is included instead of the diplexer 62 and that a coupler 71C is included instead of the coupler 71.

The triplexer 80 is an example of a second multiplexer and is connected to the antenna terminal 51Bad included in the antenna switch 51Ba of the first primary module 2Ba, the antenna terminal 51Bbd included in the antenna switch 51Bb of the second primary module 2Bb, and the antenna 5b. To be specific, the triplexer 80 includes filters 80a, 80b, and 80c.

The filter 80a is connected between the antenna terminal 51Bad of the antenna switch 51Ba and the antenna 5b. To be specific, one end of the filter 80a is connected to the antenna terminal 51Bad via the coupler 71C and the antenna connection terminal 102a. The other end of the filter 80a is connected to the antenna 5b.

The filter 80a has, for example, at least part of a low band as a pass band. The filter 80a is a low pass filter, but may be a band pass filter. The filter 80a may have, for example, at least part of a middle band (mid-band) as a pass band.

The filter 80b is connected between the antenna terminal 51Bbd of the antenna switch 51Bb and the antenna 5b. To be specific, one end of the filter 80b is connected to the antenna terminal 51Bbd via the coupler 71C and the antenna connection terminal 102b. The other end of the filter 80b is connected to the antenna 5b.

The filter 80b has, for example, at least part of a high band as a pass band. The filter 80b is a high pass filter, but may be a band pass filter. The filter 80b may have, for example, at least part of a middle band as a pass band.

The filter 80c is connected between a transfer circuit and the antenna 5b. The transfer circuit is a circuit that processes a signal for a WLAN system. The filter 80c has a pass band including a WLAN 2.4 GHz band.

The filter 80c is, for example, a band pass filter. The pass band of the filter 80c is not limited thereto and may include a WLAN 5 GHz band.

The coupler 71C is provided for detection. The coupler 71C is provided for detecting a signal that is to be transmitted from the antenna 5a or 5b or that has been received by the antenna 5a or 5b.

The coupler 71C includes three main lines and three sub-lines coupled to the three respective main lines. One of the three main lines of the coupler 71C is connected between the antenna 5a and the diplexer 61. Another one of the three main lines of the coupler 71C is connected between the filter 80a of the triplexer 80 and the antenna connection terminal 102a of the first primary module 2Ba. The other one of the three main lines of the coupler 71C is connected between the filter 80b of the triplexer 80 and the antenna connection terminal 102b of the second primary module 2Bb. The three sub-lines of the coupler 71C are each connected to a detector. The three main lines of the coupler 71C are not coupled to each other.

The configuration of the RF circuit 1C is not limited to the example illustrated in FIG. 14. For example, the RF circuit 1C does not necessarily have to include the coupler 71C or 72. The RF circuit 1C does not necessarily have to include the diplexer 61, 63, or 64.

The triplexer 80 may be provided instead of the diplexer 63 and may be provided between the antenna 5c and the first and second diversity modules 3Ba and 3Bb. Alternatively, the triplexer 80 may be provided instead of the diplexer 61 or 64.

The operation of the RF circuit 1C according to the present embodiment is similar to the operation of the RF circuit 1B according to the third embodiment. As a result of the connection relationship between the individual terminals of the antenna switches 51Ba, 51Bb, 52Ba, and 52Bb being controlled, signals can be transmitted and received using the four antennas 5a, 5b, 5c, and 5d.

### 4.2 ADVANTAGEOUS EFFECTS AND THE LIKE

As described above, in the RF circuit 1C according to the present embodiment, the second multiplexer is the triplexer 80 including the filters 80a, 80b, and 80c. The filter 80a is connected to the antenna terminal 51Bad included in the antenna switch 51Ba, the filter 80b is connected to the antenna terminal 51Bbd included in the antenna switch 51Bb, and the filter 80c has a pass band including a WLAN 2.4 GHz band.

Accordingly, the antenna 5b can be used for both a WLAN system and an LTE or 5G-NR system. A decreased number of antennas provided in the communication device 6 contributes to a reduced size of the communication device 6.

### Other Embodiments

The RF circuits and communication devices according to embodiments of the present disclosure have been described above. The RF circuit and communication device according to the present invention are not limited to the above embodiments and the like. Another embodiment implemented by combining any constituent elements in the above embodiments and the like, modifications obtained by applying various changes conceived by those skilled in the art to the above embodiments without departing from the gist of the present disclosure, and various devices including any of the above-described RF circuits are also included in the present disclosure.

For example, in the RF circuits according to the above embodiments and modifications, another circuit element, wiring line, and the like may be inserted between individual circuit elements and paths connecting signal paths disclosed in the drawings.

In addition, an embodiment obtained by applying various changes conceived by those skilled in the art to the above embodiments, and an embodiment implemented by combining any constituent elements and functions in the above embodiments without departing from the gist of the present disclosure are also included in the present disclosure.

Hereinafter, the features of the RF circuit described based on the above embodiments will be described.

<1> A radio frequency circuit including:
a first transfer circuit including a first power amplifier, a second power amplifier, and a first switch circuit; and
a second transfer circuit including a third power amplifier and a second switch circuit, in which
the first switch circuit includes a first input/output terminal, a second input/output terminal, a first antenna terminal, a second antenna terminal, a first terminal, and a second terminal,
the second switch circuit includes a third input/output terminal, a third antenna terminal, a fourth antenna terminal, a third terminal, and a fourth terminal,
the first power amplifier is connected to the first input/output terminal,
the second power amplifier is connected to the second input/output terminal,
the third power amplifier is connected to the third input/output terminal,
the first terminal is connected to the third terminal,
the second terminal is connected to the fourth terminal, and
the first input/output terminal, the second input/output terminal, and the third input/output terminal are each selectively connectable to the first antenna terminal, the second antenna terminal, the third antenna terminal, and the fourth antenna terminal.

<2> The radio frequency circuit according to <1>, in which
the first transfer circuit further includes:
   a first filter connected between the first power amplifier and the first input/output terminal and having a pass band including at least part of a first band; and
   a second filter connected between the second power amplifier and the second input/output terminal and having a pass band including at least part of a second band, and
the second transfer circuit further includes:
   a third filter connected between the third power amplifier and the third input/output terminal and having a pass band including at least part of the second band.

<3> The radio frequency circuit according to <2>, in which
when the first switch circuit is in a state in which
   one of the first antenna terminal and the second antenna terminal is connected to the first input/output terminal, and
   another of the first antenna terminal and the second antenna terminal is connected to the second input/output terminal,
the second switch circuit is in a state in which
   one of the third antenna terminal and the fourth antenna terminal is connected to the third input/output terminal.

<4> The radio frequency circuit according to <2> or <3>, in which
when the first switch circuit is in a state in which
   one of the first antenna terminal and the second antenna terminal is connected to the second terminal,
   another of the first antenna terminal and the second antenna terminal is connected to the second input/output terminal, and
   the first terminal is connected to the first input/output terminal,
the second switch circuit is in a state in which
   one of the third antenna terminal and the fourth antenna terminal is connected to the third terminal, and
   the fourth terminal is connected to the third input/output terminal.

<5> The radio frequency circuit according to any one of <2> to <4>, in which
when the first switch circuit is in a state in which
   one of the first antenna terminal and the second antenna terminal is connected to the first input/output terminal, and
   the first terminal is connected to the second input/output terminal,
the second switch circuit is in a state in which
   one of the third antenna terminal and the fourth antenna terminal is connected to the third input/output terminal, and
   another of the third antenna terminal and the fourth antenna terminal is connected to the third terminal.

<6> The radio frequency circuit according to <1>, in which
the second transfer circuit further includes a low-noise amplifier,
the second switch circuit further includes a fourth input/output terminal connected to the low-noise amplifier, and
the fourth input/output terminal is connectable to the first antenna terminal, the second antenna terminal, the third antenna terminal, and the fourth antenna terminal.

<7> The radio frequency circuit according to <6>, in which
the first transfer circuit further includes:
   a first filter connected between the first power amplifier and the first input/output terminal and having a pass band including at least part of a first band; and
   a second filter connected between the second power amplifier and the second input/output terminal and having a pass band including at least part of a second band, and
the second transfer circuit further includes:
   a third filter connected between the third power amplifier and the third input/output terminal and having a pass band including at least part of the second band; and
   a fourth filter connected between the low-noise amplifier and the fourth input/output terminal and having a pass band including at least part of the first band.

<8> The radio frequency circuit according to <7>, in which
when the first switch circuit is in a state in which
   one of the first antenna terminal and the second antenna terminal is connected to the first input/output terminal, and
   another of the first antenna terminal and the second antenna terminal is connected to the second input/output terminal,
the second switch circuit is in a state in which
   one of the third antenna terminal and the fourth antenna terminal is connected to the third input/output terminal, and
   another of the third antenna terminal and the fourth antenna terminal is connected to the fourth input/output terminal.

<9> The radio frequency circuit according to <7> or <8>, in which
when the first switch circuit is in a state in which
   one of the first antenna terminal and the second antenna terminal is connected to the second terminal,
   another of the first antenna terminal and the second antenna terminal is connected to the second input/output terminal, and
   the first terminal is connected to the first input/output terminal,
the second switch circuit is in a state in which
   one of the third antenna terminal and the fourth antenna terminal is connected to the third terminal,
   another of the third antenna terminal and the fourth antenna terminal is connected to the fourth input/output terminal, and
   the fourth terminal is connected to the third input/output terminal.

<10> The radio frequency circuit according to any one of <7> to <9>, in which
when the first switch circuit is in a state in which
   one of the first antenna terminal and the second antenna terminal is connected to the first input/output terminal,
   another of the first antenna terminal and the second antenna terminal is connected to the second terminal, and
   the first terminal is connected to the second input/output terminal,
the second switch circuit is in a state in which
   one of the third antenna terminal and the fourth antenna terminal is connected to the third input/output terminal,
   another of the third antenna terminal and the fourth antenna terminal is connected to the third terminal, and
the fourth terminal is connected to the fourth input/output terminal.

<11> The radio frequency circuit according to any one of <1> to <10>, in which the first transfer circuit is implemented on or in a substrate, and the second transfer circuit is implemented on or in another substrate.

<12> The radio frequency circuit according to <2>, in which
the first antenna terminal of the first switch circuit includes at least two first antenna terminals, the second antenna terminal of the first switch circuit includes at least two second antenna terminals, the first terminal of the first switch circuit includes at least two first terminals, and the second terminal of the first switch circuit includes at least two second terminals,
the first switch circuit includes:
   a first switch including the first input/output terminal, one of the at least two first antenna terminals, one of the at least two second antenna terminals, one of the at least two first terminals, and one of the at least two second terminals; and
   a second switch including the second input/output terminal, another one of the at least two first antenna terminals, another one of the at least two second antenna terminals, another one of the at least two first terminals, and another one of the at least two second terminals,
the third antenna terminal of the second switch circuit includes at least two third antenna terminals, the fourth antenna terminal of the second switch circuit includes at least two fourth antenna terminals, the third terminal of the second switch circuit includes at least two third terminals, and the fourth terminal of the second switch circuit includes at least two fourth terminals, and
the second switch circuit includes:
   a third switch including the third input/output terminal, one of the at least two third antenna terminals, one of the at least two fourth antenna terminals, one of the at least two third terminals, and one of the at least two fourth terminals; and
   a fourth switch including another one of the at least two third antenna terminals, another one of the at least two fourth antenna terminals, another one of the at least two third terminals, and another one of the at least two fourth terminals.

<13> The radio frequency circuit according to <12>, in which
the second transfer circuit further includes a low-noise amplifier,
the fourth switch further includes a fourth input/output terminal connected to the low-noise amplifier, and
the fourth input/output terminal is connectable to the one of the at least two first antenna terminals, the one of the at least two second antenna terminals, the another one of the at least two third antenna terminals, and the another one of the at least two fourth antenna terminals.

<14> The radio frequency circuit according to <13>, in which
when the first switch circuit is in a state in which
   one of the first antenna terminal and the second antenna terminal included in the first switch is connected to the first input/output terminal, and
   one of the first antenna terminal and the second antenna terminal included in the second switch is connected to the second input/output terminal,
the second switch circuit is in a state in which
   one of the third antenna terminal and the fourth antenna terminal included in the third switch is connected to the third input/output terminal, and
   one of the third antenna terminal and the fourth antenna terminal included in the fourth switch is connected to the fourth input/output terminal.

<15> The radio frequency circuit according to <13> or <14>, in which
when the first switch circuit is in a state in which
   one of the first antenna terminal and the second antenna terminal included in the second switch is connected to the second terminal included in the second switch,
   another of the first antenna terminal and the second antenna terminal included in the second switch is connected to the second input/output terminal, and
   the first terminal included in the first switch is connected to the first input/output terminal,
the second switch circuit is in a state in which
   one of the third antenna terminal and the fourth antenna terminal included in the fourth switch is connected to the third terminal included in the fourth switch,
   another of the third antenna terminal and the fourth antenna terminal included in the fourth switch is connected to the fourth input/output terminal, and
   the fourth terminal included in the third switch is connected to the third input/output terminal.

<16> The radio frequency circuit according to any one of <13> to <15>, in which
when the first switch circuit is in a state in which
   one of the first antenna terminal and the second antenna terminal included in the first switch is connected to the first input/output terminal,
   another of the first antenna terminal and the second antenna terminal included in the first switch is connected to the second terminal included in the first switch, and
   the first terminal included in the second switch is connected to the second input/output terminal,
the second switch circuit is in a state in which
   one of the third antenna terminal and the fourth antenna terminal included in the third switch is connected to the third input/output terminal,
   another of the third antenna terminal and the fourth antenna terminal included in the third switch is connected to the third terminal included in the third switch, and
   the fourth inter-module terminal included in the fourth switch is connected to the fourth input/output terminal.

<17> The radio frequency circuit according to any one of <13> to <16>, further including:
a first multiplexer connected to the first antenna terminal included in the first switch, the first antenna terminal included in the second switch, and a first antenna;
a second multiplexer connected to the second antenna terminal included in the first switch, the second antenna terminal included in the second switch, and a second antenna;
a third multiplexer connected to the third antenna terminal included in the third switch, the third antenna terminal included in the fourth switch, and a third antenna; and
a fourth multiplexer connected to the fourth antenna terminal included in the third switch, the fourth antenna terminal included in the fourth switch, and a fourth antenna.

<18> The radio frequency circuit according to <17>, in which
the second multiplexer is a triplexer including a fifth filter, a sixth filter, and a seventh filter,
the fifth filter is connected to the second antenna terminal included in the first switch,
the sixth filter is connected to the second antenna terminal included in the second switch, and
the seventh filter has a pass band including a WLAN 2.4 GHz band.

<19> The radio frequency circuit according to any one of <13> to <18>, in which
the first switch and the first power amplifier are implemented on or in a first substrate,
the second switch and the second power amplifier are implemented on or in a second substrate,
the third switch and the third power amplifier are implemented on or in a third substrate, and
the fourth switch and the low-noise amplifier are implemented on or in a fourth substrate.

<20> A communication device including:
the radio frequency circuit according to any one of <1> to <19>; and
a signal processing circuit configured to process a radio frequency signal transferred in the radio frequency circuit.

The present invention can be widely used, as an RF circuit to be disposed in a front end portion, in communication devices such as mobile phones. The scope of the invention is indicated by the appended claims, rather than the foregoing description.

What is claimed is:

1. A radio frequency circuit comprising:
a first transfer circuit including a first power amplifier, a second power amplifier, and a first switch circuit; and
a second transfer circuit including a third power amplifier and a second switch circuit, wherein
the first switch circuit includes a first input/output terminal, a second input/output terminal, a first antenna terminal, a second antenna terminal, a first inter-module terminal, and a second inter-module terminal,
the second switch circuit includes a third input/output terminal, a third antenna terminal, a fourth antenna terminal, a third inter-module terminal, and a fourth inter-module terminal,
the first power amplifier is connected to the first input/output terminal,
the second power amplifier is connected to the second input/output terminal,
the third power amplifier is connected to the third input/output terminal,
the first inter-module terminal is connected to the third inter-module terminal,
the second inter-module terminal is connected to the fourth inter-module terminal, and
the first input/output terminal, the second input/output terminal, and the third input/output terminal are each selectively connectable to the first antenna terminal, the second antenna terminal, the third antenna terminal, and the fourth antenna terminal.

2. The radio frequency circuit according to claim 1, wherein
the first transfer circuit further includes:
a first filter connected between the first power amplifier and the first input/output terminal and having a pass band including at least part of a first band; and
a second filter connected between the second power amplifier and the second input/output terminal and having a pass band including at least part of a second band, and
the second transfer circuit further includes:
a third filter connected between the third power amplifier and the third input/output terminal and having a pass band including at least part of the second band.

3. The radio frequency circuit according to claim 2, wherein
when the first switch circuit is in a state in which
one of the first antenna terminal and the second antenna terminal is connected to the first input/output terminal, and
a different one of the first antenna terminal and the second antenna terminal is connected to the second input/output terminal,
the second switch circuit is in a state in which
one of the third antenna terminal and the fourth antenna terminal is connected to the third input/output terminal.

4. The radio frequency circuit according to claim 2, wherein
when the first switch circuit is in a state in which
one of the first antenna terminal and the second antenna terminal is connected to the second inter-module terminal,
a different one of the first antenna terminal and the second antenna terminal is connected to the second input/output terminal, and
the first inter-module terminal is connected to the first input/output terminal,
the second switch circuit is in a state in which
one of the third antenna terminal and the fourth antenna terminal is connected to the third inter-module terminal, and
the fourth inter-module terminal is connected to the third input/output terminal.

5. The radio frequency circuit according to claim 2, wherein
when the first switch circuit is in a state in which
one of the first antenna terminal and the second antenna terminal is connected to the first input/output terminal, and
the first inter-module terminal is connected to the second input/output terminal,
the second switch circuit is in a state in which
one of the third antenna terminal and the fourth antenna terminal is connected to the third input/output terminal, and
a different one of the third antenna terminal and the fourth antenna terminal is connected to the third inter-module terminal.

6. The radio frequency circuit according to claim 1, wherein
the second transfer circuit further includes a low-noise amplifier,
the second switch circuit further includes a fourth input/output terminal connected to the low-noise amplifier, and
the fourth input/output terminal is connectable to the first antenna terminal, the second antenna terminal, the third antenna terminal, and the fourth antenna terminal.

7. The radio frequency circuit according to claim 6, wherein
the first transfer circuit further includes:
a first filter connected between the first power amplifier and the first input/output terminal and having a pass band including at least part of a first band; and
a second filter connected between the second power amplifier and the second input/output terminal and having a pass band including at least part of a second band, and
the second transfer circuit further includes:
a third filter connected between the third power amplifier and the third input/output terminal and having a pass band including at least part of the second band; and
a fourth filter connected between the low-noise amplifier and the fourth input/output terminal and having a pass band including at least part of the first band.

8. The radio frequency circuit according to claim 7, wherein
when the first switch circuit is in a state in which
one of the first antenna terminal and the second antenna terminal is connected to the first input/output terminal, and
a different one of the first antenna terminal and the second antenna terminal is connected to the second input/output terminal,
the second switch circuit is in a state in which
one of the third antenna terminal and the fourth antenna terminal is connected to the third input/output terminal, and
a different one of the third antenna terminal and the fourth antenna terminal is connected to the fourth input/output terminal.

9. The radio frequency circuit according to claim 7, wherein
when the first switch circuit is in a state in which
one of the first antenna terminal and the second antenna terminal is connected to the second inter-module terminal,
a different one of the first antenna terminal and the second antenna terminal is connected to the second input/output terminal, and
the first inter-module terminal is connected to the first input/output terminal,
the second switch circuit is in a state in which
one of the third antenna terminal and the fourth antenna terminal is connected to the third inter-module terminal,
a different one of the third antenna terminal and the fourth antenna terminal is connected to the fourth input/output terminal, and
the fourth inter-module terminal is connected to the third input/output terminal.

10. The radio frequency circuit according to claim 7, wherein
when the first switch circuit is in a state in which
one of the first antenna terminal and the second antenna terminal is connected to the first input/output terminal,
a different one of the first antenna terminal and the second antenna terminal is connected to the second inter-module terminal, and
the first inter-module terminal is connected to the second input/output terminal,
the second switch circuit is in a state in which
one of the third antenna terminal and the fourth antenna terminal is connected to the third input/output terminal,
a different one of the third antenna terminal and the fourth antenna terminal is connected to the third inter-module terminal, and
the fourth inter-module terminal is connected to the fourth input/output terminal.

11. The radio frequency circuit according to claim 1, wherein the first transfer circuit is implemented on or in a substrate, and the second transfer circuit is implemented on or in another substrate.

12. The radio frequency circuit according to claim 2, wherein
the first antenna terminal of the first switch circuit includes at least two first antenna terminals, the second antenna terminal of the first switch circuit includes at least two second antenna terminals, the first inter-module terminal of the first switch circuit includes at least two first inter-module terminals, and the second inter-module terminal of the first switch circuit includes at least two second inter-module terminals,
the first switch circuit includes:
a first switch including the first input/output terminal, one of the at least two first antenna terminals, one of the at least two second antenna terminals, one of the at least two first inter-module terminals, and one of the at least two second inter-module terminals; and
a second switch including the second input/output terminal, another one of the at least two inter-module first antenna terminals, another one of the at least two inter-module second antenna terminals, another one of the at least two first inter-module terminals, and another one of the at least two second inter-module terminals,
the third antenna terminal of the second switch circuit includes at least two third antenna terminals, the fourth antenna terminal of the second switch circuit includes at least two fourth antenna terminals, the third inter-module terminal of the second switch circuit includes at least two third inter-module terminals, and the fourth inter-module terminal of the second switch circuit includes at least two fourth inter-module terminals, and
the second switch circuit includes:
a third switch including the third input/output terminal, one of the at least two third antenna terminals, one of the at least two fourth antenna terminals, one of the at least two third inter-module terminals, and one of the at least two fourth inter-module terminals; and
a fourth switch including another one of the at least two third antenna terminals, another one of the at least two fourth antenna terminals, another one of the at least two third inter-module terminals, and another one of the at least two fourth inter-module terminals.

13. The radio frequency circuit according to claim 12, wherein
the second transfer circuit further includes a low-noise amplifier,
the fourth switch further includes a fourth input/output terminal connected to the low-noise amplifier, and
the fourth input/output terminal is connectable to the one of the at least two first antenna terminals, the one of the at least two second antenna terminals, the another one of the at least two third antenna terminals, and the another one of the at least two fourth antenna terminals.

14. The radio frequency circuit according to claim 13, wherein
when the first switch circuit is in a state in which
one of the first antenna terminal and the second antenna terminal included in the first switch is connected to the first input/output terminal, and
one of the first antenna terminal and the second antenna terminal included in the second switch is connected to the second input/output terminal,
the second switch circuit is in a state in which
one of the third antenna terminal and the fourth antenna terminal included in the third switch is connected to the third input/output terminal, and
one of the third antenna terminal and the fourth antenna terminal included in the fourth switch is connected to the fourth input/output terminal.

15. The radio frequency circuit according to claim 13, wherein
when the first switch circuit is in a state in which
one of the first antenna terminal and the second antenna terminal included in the second switch is connected to the second inter-module terminal included in the second switch,
a different one of the first antenna terminal and the second antenna terminal included in the second switch is connected to the second input/output terminal, and
the first inter-module terminal included in the first switch is connected to the first input/output terminal,
the second switch circuit is in a state in which
one of the third antenna terminal and the fourth antenna terminal included in the fourth switch is connected to the third inter-module terminal included in the fourth switch,
a different one of the third antenna terminal and the fourth antenna terminal included in the fourth switch is connected to the fourth input/output terminal, and
the fourth inter-module terminal included in the third switch is connected to the third input/output terminal.

16. The radio frequency circuit according to claim 13, wherein
when the first switch circuit is in a state in which
one of the first antenna terminal and the second antenna terminal included in the first switch is connected to the first input/output terminal,
a different one of the first antenna terminal and the second antenna terminal included in the first switch is connected to the second inter-module terminal included in the first switch, and
the first inter-module terminal included in the second switch is connected to the second input/output terminal,
the second switch circuit is in a state in which
one of the third antenna terminal and the fourth antenna terminal included in the third switch is connected to the third input/output terminal,
a different one of the third antenna terminal and the fourth antenna terminal included in the third switch is connected to the third inter-module terminal included in the third switch, and
the fourth inter-module terminal included in the fourth switch is connected to the fourth input/output terminal.

17. The radio frequency circuit according to claim 13, further comprising:
a first multiplexer connected to the first antenna terminal included in the first switch, the first antenna terminal included in the second switch, and a first antenna;
a second multiplexer connected to the second antenna terminal included in the first switch, the second antenna terminal included in the second switch, and a second antenna;
a third multiplexer connected to the third antenna terminal included in the third switch, the third antenna terminal included in the fourth switch, and a third antenna; and
a fourth multiplexer connected to the fourth antenna terminal included in the third switch, the fourth antenna terminal included in the fourth switch, and a fourth antenna.

18. The radio frequency circuit according to claim 17, wherein
the second multiplexer is a triplexer including a fifth filter, a sixth filter, and a seventh filter,
the fifth filter is connected to the second antenna terminal included in the first switch,
the sixth filter is connected to the second antenna terminal included in the second switch, and
the seventh filter has a pass band including a WLAN 2.4 GHz band.

19. The radio frequency circuit according to claim 13, wherein
the first switch and the first power amplifier are implemented on or in a first substrate,
the second switch and the second power amplifier are implemented on or in a second substrate,
the third switch and the third power amplifier are implemented on or in a third substrate, and
the fourth switch and the low-noise amplifier are implemented on or in a fourth substrate.

20. A communication device comprising:
the radio frequency circuit according to claim 1; and
a signal processing circuit configured to process a radio frequency signal transferred in the radio frequency circuit.
